(19) United States
(12) Patent Application Publication
(10) Pub. No.: US 2026/0299389 A1
(43) Pub. Date: Oct. 1, 2026

(54) OPTICAL MODULE AND PROJECTOR

(71) Applicant: SEIKO EPSON CORPORATION, Tokyo (JP)

(72) Inventors: Kiyomi SATO, MATSUMOTO-SHI (JP); Tomoya MIZUTANI, AZUMINO-SHI (JP)

(21) Appl. No.: 19/578,131

(22) Filed: Mar. 25, 2026

(30) Foreign Application Priority Data
Mar. 26, 2025 (JP) 2025-051588

(51) Int. Cl. G03B 21/20

(52) U.S. Cl. CPC G03B 21/2066; G03B 21/2013; G03B 21/208

(57) ABSTRACT

An optical module according to an embodiment includes: a first light source configured to emit first light in a first wavelength band; a first pickup element configured to reduce a spread angle of the first light emitted from the first light source; and a first light modulation element configured to modulate the first light. The first light modulation element has a light receiving region that receives the first light. A predetermined appropriate condition is satisfied among an area of the light receiving region, an area of a first emission end of the first light guide element of the first pickup element, an area of a first incident end of the first light guide element, an angle formed by the first light emitted from the first pickup element, an etendue of the light receiving region, and an etendue in an emission region of the first light in the first pickup element.

The present application is based on, and claims priority from JP Application Serial Number 2025-051588, filed Mar. 26, 2025, the disclosure of which is hereby incorporated by reference herein in its entirety.

### BACKGROUND

### 1. Technical Field

The present disclosure relates to an optical module and a projector.

### 2. Related Art

There is a known projector in the related art including a light source that emits color light, a light modulation element that modulates the color light emitted from the light source to generate image light, and a projection optical system that projects the image light emitted from the light modulation element. Projectors are classified into a single-plate projector, a two-plate projector, a three-plate projector, and other types of projectors according to the numbers of light sources and light modulation elements.

For example, JP-A-2000-180962 discloses a projector using a plurality of light emitting diodes (LEDs) as light emitting elements in light sources. In a projector disclosed in JP-A-2000-180962, a plurality of types of color light emitted from the LEDs pass through blocks, are then superimposed on one another on a path oriented in one direction, and the superimposed color light is modulated by a light modulation element into image light, which is projected by a projection lens. Brightness of the color light emitted from an emission end of each of the blocks is homogenized in planes that intersect with an optical axis. The color light emitted from the plurality of blocks is incident on a cross dichroic prism for combining the light from the plurality of LEDs with each other.

JP-A-2000-180962 is an example of the related art.

In the projector disclosed in JP-A-2000-180962 described above, an incident end of the block is in close contact with the light source. The emission end having a larger cross-sectional area than the incident end of the block is in close contact with the cross dichroic prism or is in close contact with an optical lens for causing the color light to be incident on the cross dichroic prism. With these configurations, light use efficiency in the projector is improved. When a relative relationship among a dimension of a light emitting surface of the light source, radiation characteristics of the color light emitted from the light emitting surface, a dimension of each of the incident end and the emission end of the block, and a shape and a dimension of the optical lens is close to optimum conditions, an amount of the color light that is emitted to outside of a modulation surface and is lost among the color light incident on the modulation surface of the light modulation element is reduced, and the light use efficiency in the projector is further improved. Meanwhile, when a light intensity of the color light received in a region on an outer peripheral side of the modulation surface of the light modulation element relatively decreases, illuminance unevenness of the image light emitted from the light modulation element increases, and there is a possibility that display quality decreases more than expected. In the projector disclosed in JP-A-2000-180962, it is expected that the display quality is secured and the light use efficiency is further improved in consideration of a manufacturing error of components during mass production of the projector according to a dimension and a specification of the light source, parameters related to the optical characteristics, and the shape and the dimension of the block.

### SUMMARY

An optical module according to an aspect of the present disclosure includes: a first light source configured to emit first light in a first wavelength band; a first pickup element configured to reduce a spread angle of the first light emitted from the first light source; and a first light modulation element configured to modulate the first light emitted from the first pickup element based on image information. The first light modulation element has a light receiving region that receives light emitted from the first pickup element. The first pickup element has a first light guide element. The first light guide element includes a first incident end on which the first light is incident and a first emission end from which the first light is emitted, and homogenizes in-plane illuminance of the first light. When an area of the light receiving region when viewed along an optical axis of the first light is AR1, an area of the first emission end of the first light guide element on which the first light is emitted is AR2, an area of the first incident end of the first light guide element on which the first light is incident is AR3, an angle formed by the first light emitted from the first pickup element with respect to the optical axis is θ1, an etendue of the light receiving region in the first light modulation element is ET1, and an etendue in an emission region of the first light incident on the first pickup element is ET2, the following Equations (1) and (2) are satisfied.

$$1.1 \times AR 1 \leq AR 2 \leq 1.9 \times AR 1 \qquad ( 1 )$$

$$ET 2 = π \times AR 3 \times {sin}^{2} θ1 \leq ET 1 \qquad ( 2 )$$

### BRIEF DESCRIPTION OF THE DRAWINGS

FIG. 1 is a schematic view showing a configuration of a projector according to an embodiment.

FIG. 2 is a perspective view of a light guide element for green light in an optical module of the projector shown in FIG. 1.

FIG. 3 is a side view of a light guide element and a parallelizing element for green light in the optical module of the projector shown in FIG. 1.

FIG. 4 is a schematic view of a light modulation element for green light in the optical module of the projector shown in FIG. 1.

FIG. 5 is a graph showing a relationship between a distance from a center of a light receiving region of the light modulation element for green light and a relative intensity of the green light incident on the light modulation element in the optical module of FIG. 1, and depending on a relationship between an area of an emission end of the light guide element for the green light and an area of the light receiving region of the light modulation element.

FIG. 6 is a graph showing a relationship between the distance from the center of the light receiving region of the light modulation element for green light in the optical module of FIG. 1 and a relative intensity of the green light incident on the light modulation element, and is an enlarged view of a part of FIG. 5.

FIG. 7 is a graph showing a relationship between the area of the emission end of the light guide element for green light and use efficiency of the green light in the light modulation element in the optical module of FIG. 1.

FIG. 8 is a side view of a light source for green light and a pickup element in the optical module of the projector shown in FIG. 1.

FIG. 9 is a graph showing a relationship between a distance from the center of the light receiving region of the light modulation element for green light in the optical module of FIG. 1 and the relative intensity of the green light incident on the light modulation element, and depending on a relationship between an area of an incident end of the light guide element for green light and an area of a light emitting surface of the light source.

FIG. 10 is a graph showing a relationship between the distance from the center of the light receiving region of the light modulation element for green light in the optical module of FIG. 1 and the relative intensity of the green light incident on the light modulation element, and is an enlarged view of a part of FIG. 9.

FIG. 11 is a side view of a light source for green light and a pickup element in an optical module according to a first modification of the present embodiment.

### DESCRIPTION OF EMBODIMENTS

An embodiment of the present disclosure will be described below with reference to the drawings. In the drawings, elements are drawn at different dimensional scales in some cases for clarity of each of the elements.

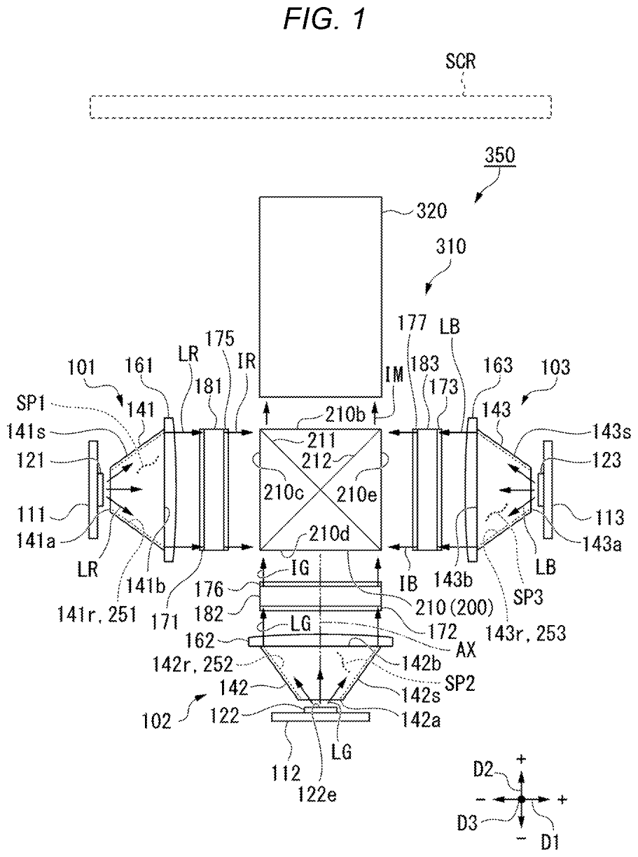

An embodiment of the present disclosure will first be described with reference to FIGS. 1 to 10. FIG. 1 is a schematic view showing a configuration of a projector 350 according to the embodiment of the present disclosure. The projector 350 is an image display device including three liquid crystal panels corresponding to color light of three primary colors as light modulation elements, and is a so-called three-plate projector.

The projector 350 includes an optical module 310 and a projection optical system 320, as shown in FIG. 1. The optical module 310 includes a red light emitting portion 101, a green light emitting portion 102, a blue light emitting portion 103, light-incident-side polarization elements 171, 172, and 173, light modulation elements 181, 182, and 183, light-emission-side polarization elements 175, 176, and 177, and a light combining element 200.

The red light emitting portion 101 emits red light LR. In the following description, an axis parallel to an optical axis of the red light LR emitted from the red light emitting portion 101 is defined as a D1 direction. One side in the D1 direction is defined as a −D1 side, and the side opposite the −D1 side in the D1 direction is defined as a +D1 side. A direction orthogonal to the D1 direction in a plane including the optical axis of the red light LR is defined as a D2 direction. One side in the D2 direction is referred to as a −D2 side, and the side opposite the −D2 side in the D2 direction is defined as a +D2 side. A direction orthogonal to the D1 and D2 directions is referred to as a D3 direction. The red light LR emitted from the red light emitting portion 101 travels toward the +D1 side along the D1 direction.

The red light emitting portion 101 includes a light source 121 and a pickup element 401. The light sources 121 are supported by a substrate 111. The light source 121 is provided at a +D1-side plate surface of the substrate 111 among plate surfaces of the substrate 111 that are parallel to a plane including the D2 and D3 directions. A light emitting surface of the light source 121 is disposed substantially in parallel to the plane including the D2 and D3 directions, and is a surface opposite in the D1 direction to the surface of the light source 121 that is in contact with the +D1-side plate surface of the substrate 111.

The light source 121 corresponds to a second light source, and emits the red light LR having a red wavelength band in a visible wavelength band. The red wavelength band corresponds to a second wavelength band. The red light LR corresponds to second light. The red light LR diverges from the light emitting surface of the light source 121 according to a predetermined radiation angle around the axis passing through the center of the light emitting surface of the light source 121 and parallel to the D1 direction, and is emitted toward the +D1 side. The red wavelength band is, for example, a wavelength band ranging from 590 nm to 700 nm, and includes, for example, 630 nm.

The light source 121 is implemented, for example, with an LED that emits the red light LR. The LED that emits the red light LR contains, for example, aluminum gallium indium phosphide (AlGaInP) having excellent light extraction efficiency as a light emitter.

The red light LR emitted from the light source 121 spreads at a predetermined radiation angle as proceeding from the −D1 side to the +D1 side along the optical axis from the light emitting surface. A spread angle of the red light LR emitted from the light source 121 depends on the radiation angle described above, is within 90°, and is determined by a material of the light source 121. For example, an angle formed by the optical axis parallel to the D1 direction and a light beam of the red light LR that spreads most is within 45°.

The light source 121 may include one LED or a plurality of LEDs as a whole. When the light source 121 includes a plurality of LEDs, the plurality of LEDs are arranged in a region occupied by the light source 121 in a plane including the D2 and D3 directions.

By using the LED as the light source 121, cost of the light source 121 is reduced, and speckle noise of the red light included in the image light IM projected on a screen SCR is reduced.

The substrate 111 is made of, for example, metal, and also acts as a heat dissipation member that receives heat from the light source 121 emitting the red light LR and dissipates the heat to an external space.

The pickup element 401 is provided in an optical path of the red light LR emitted from the light source 121, and is disposed on the +D1 side of the light source 121 at a position where the pickup element 401 overlaps the light source 121 in the D2 and D3 directions. The pickup element 401 includes, for example, a light guide element 141 and a parallelizing element 161, and corresponds to a second pickup element.

The light guide element 141 is provided in the optical path of the red light LR emitted from the light source 121, and is disposed on the +D1 side of the light source 121 at a position where the light guide element 141 overlaps the light source 121 in the D2 and D3 directions. The light guide element 141 corresponds to a second light guide element, and includes an incident end 141a on the −D1 side in the D1 direction, an emission end 141b on the +D1 side, and a side surface 141s and a reflection surface 141r extending between the incident end 141a and the emission end 141b in the D1 direction.

The incident end 141a corresponds to a second incident end and spreads in parallel to a plane including the D2 and D3 directions. A shape of the incident end 141a viewed in the D1 direction is the same as a shape of the light emitting surface of the light source 121 viewed in the same direction, and is, for example, a quadrangular shape, specifically, a rectangular shape. The sizes of the light emitting surface of the light source 121 in the D2 and D3 directions are each, for example, 0.25 mm or more and 10 mm or less. The area of the light emitting surface of the light source 121 when viewed along the D1 direction is, for example, 0.25 mm×0.25 mm to 10 mm×10 mm.

The sizes of the incident end 141a in a plane including the D2 and D3 directions may be equal to the sizes of the light emitting surface of the light source 121 in a plane including the D2 and D3 directions, and are preferably appropriately greater than the sizes of the light emitting surface of the light source 121 in the plane including the D2 and D3 directions. A dimension along a long side parallel to the D2 direction of an opening on which the red light LR is incident at the incident end 141a is 1 mm or more and 3 mm or less, for example, about 2 mm.

The emission end 141b corresponds to a second emission end, spreads in parallel to a plane including the D2 and D3 directions, and is larger than the incident end 141a. The shape of the emission end 141b viewed in the D1 direction is the same as the shape of the light modulation surface of a light modulation element 181 viewed in the same direction, and is, for example, a quadrangular shape. The sizes of the emission end 141b in a plane including the D2 and D3 directions are equal to the sizes of a modulation surface of the light modulation element 181 in a plane including the D2 and D3 directions.

The dimension along the long side parallel to the D2 direction of the opening from which the red light LR is emitted at the emission end 141b is 14 mm or more and 16 mm or less, for example, about 15 mm. The size of the modulation surface of the light modulation element 181 in a long side direction, that is, the D2 direction is, for example, 15 mm. The size of the modulation surface of the light modulation element 181 may be appropriately selected in a range from 6.48 mm×11.52 mm of a 0.52 inch type to 19.44 mm×34.56 mm of a 1.5 inch type, for example.

The side surfaces 141s and the reflection surfaces 141r couple a peripheral edge portion of the incident end 141a to a peripheral edge portion of the emission end 141b in the D1 direction.

The red light LR emitted from the light source 121 is incident on the light guide element 141 from the incident end 141a. In the light guide element 141, an internal space SP1 surrounded by the incident end 141a, the emission end 141b, and the reflection surface 141r is a region in which the red light LR propagates. A size of the internal space SP1 of the light guide element 141 in a plane including the D2 and D3 directions increases as the internal space proceeds from the −D1 side toward the +D1 side in the D1 direction.

A cross-sectional area of the emission end 141b of the light guide element 141 that includes the D2 and D3 directions, that is, an area occupied by a cross section of the emission end 141b that is parallel to a plane orthogonal to a central axis of the light guide element 141 that is parallel to the D1 direction is greater than a cross-sectional area of the incident end 141a of the light guide element 141 that includes the same directions, that is, the area occupied by the cross section of the incident end 141a of the light guide element 141 that is parallel to the plane orthogonal to the central axis of the light guide element 141. The area occupied by the cross section orthogonal to the central axis of the light guide element 141 increases as the light guide element 141 extends from the incident end 141a toward the emission end 141b.

A shape of the internal space SP1 of the light guide element 141 in a plane including the D2 and D3 directions changes from the shape of the light emitting surface of the light source 121 when viewed from the D1 direction to the shape of the modulation surface of the light modulation element 181 as the internal space proceeds from the −D1 side toward the +D1 side.

The side surface 141s of the light guide element 141 and the reflection surface 141r provided at the side surface 141s as will be described later form a predetermined angle with respect to an imaginary line orthogonal to the incident end 141a and the central axis of the light guide element 141, and are separate away from the imaginary line in a plane including the D2 and D3 directions as the light guide element 141 extends from the −D1 side toward the +D1 side. The red light LR that is incident on the light guide element 141 propagates through the internal space SP1 of the light guide element 141 from the −D1 side toward the +D1 side.

The modulation surface of the light modulation element 181 has a rectangular shape when viewed along the D1 direction, and the light emitting surface of the light source 121 has a rectangular shape when viewed along the D1 direction. A predetermined angle, that is, a taper angle formed by the side surface 141s including the short side parallel to the D3 direction of the rectangular shape and the reflection surface 141r with respect to the imaginary line and the central axis of the light guide element 141 is, for example, in a range of 7° or more and 220 or less. A predetermined angle, that is, a taper angle formed by the side surface 141s including the long side parallel to the D2 direction of the rectangular shape and the reflection surface 141r with respect to the imaginary line and the central axis of the light guide element 141 is, for example, in a range of 14° or more and 36° or less. A preferable range of the taper angle is appropriately set such that a reflection film 251 of the light guide element 141 has a desired reflectance by numerical simulation based on a configuration of the red light emitting portion 101 and light beam tracing.

A part of the red light LR incident on the light guide element 141 forms an angle smaller than the predetermined taper angle with respect to the imaginary line described above and the central axis of the light guide element 141, and directly propagates from the incident end 141a to the emission end 141b without being incident even once on the reflection surfaces 141r. A remaining part of the red light LR incident on the light guide element 141 forms an angle equal to or greater than the predetermined taper angle with respect to the imaginary line described above and the central axis of the light guide element 141, is incident on the reflection surface 141r via the incident end 141a once or more times, is reflected by the reflection surface 141r, and then reaches the emission end 141b. The path of the light beam of the red light LR in the internal space SP1 of the light guide element 141 varies depending on an incident angle to the incident end 141a, and extends to a plurality of paths having different numbers of reflections on the reflection surface 141r.

The illuminance distribution of the red light LR propagating through the internal space SP1 of the light guide element 141 to the +D1 side is homogenized in a plane including the D2 and D3 directions. That is, the light guide element 141 homogenizes the illuminance distribution of incident red light LR in the plane including the D2 and D3 directions. The red light LR having a uniform illuminance distribution is emitted from the emission end 141b to the +D1 side.

The light guide element 141 takes the red light LR into the internal space SP1 from the incident end 141a, guides the red light LR to the +D1 side, and emits the red light LR from the emission end 141b, thereby reducing the spread angle of the red light LR emitted from the light source 121. The spread angle of the red light LR emitted from the light guide element 141 with respect to the optical axis is, for example, within a range of 5° to 30° as an angle formed by the optical axis parallel to the D1 direction and the light beam of the red light LR which spreads most, and is smaller than the spread angle of the red light LR emitted from the light source 121 toward the light guide element 141.

The light guide element 141 is, for example, a reflector and is formed as a hollow member. The light guide element 141 is formed, for example, in a quadrangular shape when viewed along the D1 direction, and is tapered from the emission end 141b toward the incident end 141a. When viewed along the D1 direction, an end of a reflector frame on the −D1 side has the same shape and size as the incident end 141a and the light emitting surface of the light source 121, and an end of the reflector frame on the +D1 side has the same shape and size as the emission end 141b and the modulation surface of the light modulation element 181, and is formed, for example, into a quadrangular shape having a size different from that of the end on the −D1 side.

The light guide element 141 includes, for example, a plate-shaped member and the reflection film 251. When the incident end 141a and the emission end 141b have a quadrangular shape when viewed in the D1 direction, the reflector is implemented by, for example, four plate-shaped members each having a trapezoidal shape and the reflection film 251. The light guide element 141 is implemented by, for example, the four plate-shaped members each having a trapezoidal shape with the sides corresponding to legs of the trapezoidal shape coupled to each other.

A width, that is, a dimension of each of the sides facing the −D1 side that are parallel to the D2 or D3 direction and correspond to upper bases of the four plate-shaped members of the light guide element 141 is set according to the size of the incident end 141a and the light emitting surface of the light source 121 in the D2 or D3 direction. The width, that is, the dimension of each of the sides facing the +D1 side that are parallel to the D2 or D3 direction and correspond to lower bases of the four plate-shaped members of the light guide element 141 is set according to the size of the emission end 141b and the light modulation surface of the light modulation element 181 in the D2 or D3 direction.

In consideration of the size and the like of the light source 121, the width of the end side parallel to the D2 direction on the −D1 side of two plate-shaped members among the four plate-shaped members is 1 mm or more and 3 mm or less, for example, about 2 mm. Similarly, the width of the end side parallel to the D2 direction on the +D1 side of the two plate-shaped members is 14 mm or more and 16 mm or less, for example, about 15 mm. The length in the D1 direction of the four plate-shaped members from the incident end 141a to the emission end 141b is 5 mm or more and 25 mm or less.

The material of the four plate-shaped members of the light guide element 141 contains at least any of aluminum (Al) and silver (Ag), which are metals, and glass, that is, silicon dioxide (SiO₂), which is a transparent material.

The light guide element 141 may include two rectangular plate-shaped members, two trapezoidal plate-shaped members, and the reflection film 251. Such a configuration will be described in detail later using the light guide element 142 as an example.

In the light guide element 141, in order to increase the reflectance of the red light LR incident on the light guide element 141 from the incident end 141a in the vicinity of the side surface 141s, the reflection film 251 made of a dielectric multilayer film or the like is provided on a plate surface facing the internal space SP1 of each of the four plate-shaped members constituting the reflector. A part of the red light LR incident on the internal space SP1 of the light guide element 141 from the incident end 141a is reflected by the reflection film 251 and travels to the +D1 side.

An intensity of the red light LR reflected by the reflection film 251 and emitted from the reflection film 251 may depend on the incident angle of the red light LR incident on the reflection film 251. When the reflection film 251 is formed of a dielectric multilayer film, for example, incident angle dependency of the intensity of the red light LR emitted from the reflection film 251 changes depending on parameters such as the number of layers of each of a low refractive index layer and a high refractive index layer constituting the dielectric multilayer film, a refractive index of the low refractive index layer, a refractive index of the high refractive index layer, and a refractive index difference between the low refractive index layer and the high refractive index layer. When the reflection film 251 is formed of a metal film, for example, the incident angle dependency of the intensity of the red light LR emitted from the reflection film 251 changes depending on a parameter such as the density of the metal particles.

For example, since a wavelength at which the reflectance is maximized also at a spectral reflectance of the reflection film 251 is a wavelength of about 555 nm at which human visibility is maximized, the visibility of the image projected by the projector 350 is enhanced. By adjusting the parameters of the dielectric multilayer film or the metal film constituting the reflection film 251, the wavelength at which the reflectance of the reflection film 251 is maximized can be favorably controlled.

As described above, for example, when the taper angle of the light guide element 141 is in the range of 7° or more and 220 or less, or 14° or more and 36° or less, the reflection film 251 is designed such that the incident angle of the red light LR at which the intensity of the red light LR emitted from the reflection surface 141r is the highest is in the predetermined angle range, and parameters such as the total number of each of the low refractive index layers and the high refractive index layers constituting the dielectric multilayer film and the refractive index difference between the low refractive index layers and the high refractive index layers are appropriately determined. The predetermined angle range is, for example, 60° to 90°. A relationship between the incident angle of the red light LR incident on the reflection surfaces 141r and the reflection films 251 and the intensity of the red light LR emitted from the reflection surface 141r and the reflection films 251 is derived by the numerical simulation based on the configuration of the red light emitting portion 101 and the light beam tracing.

The parallelizing element 161 is provided in the optical path of the red light LR emitted from the light guide element 141, and is disposed at a position which is shifted toward the +D1 side from the light guide element 141 and where the parallelizing element 161 overlaps the light guide element 141 in the D2 and D3 directions. The parallelizing element 161 parallelizes the red light LR emitted from the light guide element 141 along the D1 direction. The parallelizing element 161 corresponds to a second parallelizing element.

The parallelizing element 161 parallelizes the incident red light LR to reduce the spread angle of the red light LR emitted from the light guide element 141 and reduce at least the spread angle of the red light LR emitted from the light source 121. The spread angle of the red light LR emitted from the parallelizing element 161 with respect to the optical axis is, for example, within a range of 0° to 15° as an angle formed by the optical axis parallel to the D1 direction and the light beam of the red light LR which spreads most, and is further smaller than the spread angle of the red light LR emitted from the light guide element 141 toward the parallelizing element 161, and as a result, is smaller than the spread angle of the red light LR emitted from the light source 121 toward the light guide element 141.

The parallelizing element 161 is, for example, a planoconvex lens, and has an incident surface formed of a flat surface orthogonal to the D1 direction and an emission surface formed of a convex curved surface protruding to an emission side of the red light LR. A focal point of the planoconvex lens constituting the parallelizing element 161 is at least on the −D1 side with respect to the parallelizing element 161, on the side opposite to the +D1 side on which the red light LR is emitted from the parallelizing element 161, and further on the −D1 side with respect to the light guide element 141.

The incident surface of the planoconvex lens constituting the parallelizing element 161 is in contact with the emission end 141b of the light guide element 141. Since the parallelizing element 161 is in contact with the emission end 141b, the red light LR emitted from the emission end 141b of the light guide element 141 is efficiently taken into the parallelizing element 161, and loss of the red light LR can be reduced. However, the parallelizing element 161 may be an optical lens other than the planoconvex lens capable of parallelizing the incident red light LR, and may be disposed at an appropriate interval from the light guide element 141 in the D1 direction.

The light-incident-side polarization element 171 is provided on the optical path of the red light LR emitted from the parallelizing element 161, and is disposed at a position closer to the +D1 side than the parallelizing element 161 and overlapping the parallelizing element 161 in the D2 and D3 directions. The light-incident-side polarization element 171 is in contact with, for example, the light modulation element 181 at the −D1 side, and may instead be disposed at an appropriate distance from the light modulation element 181 in the D1 direction. The light-incident-side polarization element 171 emits predetermined polarized light of the red light LR emitted from the parallelizing element 161 to the +D1 side along the D1 direction. The predetermined polarized light is, for example, S-polarized light.

The light-incident-side polarization element 171 is, for example, a reflective polarization plate or an absorptive polarization plate having a plate surface parallel to a plane including the D2 and D3 directions. The light-incident-side polarization element 171 transmits a part including the predetermined polarized light of the incident red light LR to the +D1 side, and reflects or absorbs other parts of the red light LR to the −D1 side. When it is desired to prevent generation of return light and stray light to the light source 121, the light-incident-side polarization element 171 is preferably an absorptive polarization plate.

The red light LR emitted from the light source 121 includes at least P-polarized light and S-polarized light, and is, for example, randomly polarized light. A S-polarized light component of the red light LR emitted from the light source 121 sequentially passes through the light guide element 141 and the parallelizing element 161 as described above, is transmitted through the light-incident-side polarization element 171, and is emitted to the +D1 side of the light-incident-side polarization element 171. Similarly to the S-polarized light component, an P-polarized light component of the red light LR sequentially passes through the light guide element 141 and the parallelizing element 161, is reflected by the incident surface of the light-incident-side polarization element 171, and is emitted to the −D1 side of the light-incident-side polarization element 171 or is absorbed by the light-incident-side polarization element 171.

The light modulation element 181 is provided on the optical path of the red light LR emitted from the light-incident-side polarization element 171, and is disposed at a position closer to the +D1 side than the light-incident-side polarization element 171 and overlapping the light-incident-side polarization element 171 in the D2 and D3 directions. The light modulation element 181 corresponds to a second light modulation element, and modulates the red light LR emitted from the light-incident-side polarization element 171 based on image information transmitted from an image forming device such as a computer (not shown) coupled to the light modulation element 181 from the outside.

The light modulation element 181 is, for example, a transmissive liquid crystal panel. The liquid crystal panel constituting the light modulation element 181 has a plurality of pixels (not shown). The pixels each include a switching element. The switching element is, for example, a polysilicon thin film transistor (TFT). An electric signal corresponding to the brightness of the red light at a relative position of each of the pixels on the modulation surface of the light modulation element 181 in an image projected by the projector 350 is supplied to the switching element of each of the pixels. Each of the pixels modulates a vibration direction of the red light LR incident from the light-incident-side polarization element 171 by an operation of the switching element according to the electric signal described above to generate red image light IR. The image light IR corresponds to second light. The light modulation element 181 emits the image light IR generated by the liquid crystal panel toward the +D1 side along the D1 direction.

The light-emission-side polarization element 175 is provided on an optical path of the image light IR emitted from the light modulation element 181, and is disposed at a position closer to the +D1 side than the light modulation element 181 and overlapping the light modulation element 181 in the D2 and D3 directions. For example, the light-emission-side polarization element 175 is in contact with the light modulation element 181 from the +D1 side, and may be disposed at an appropriate interval from the light modulation element 181 in the D1 direction. The light-emission-side polarization element 175 emits the predetermined polarized light of the image light IR emitted from the light modulation element 181 to the +D1 side along the D1 direction. The predetermined polarized light is, for example, S-polarized light.

The light-emission-side polarization element 175 is, for example, a reflective polarization plate or an absorptive polarization plate having a plate surface parallel to a plane including the D2 and D3 directions. The light-emission-side polarization element 175 transmits a part including the predetermined polarized light of the incident image light IR to the +D1 side, and reflects or absorbs other parts of the image light IR to the −D1 side. When it is desired to reduce the generation of return light and stray light to the light modulation element 181, it is desirable to adopt the absorptive polarization plate as the light-emission-side polarization element 175.

The green light emitting portion 102 is disposed on the +D1 side and the −D2 side of the red light emitting portion 101 and is disposed in a region overlapping the red light emitting portion 101 in the D3 direction. The green light emitting portion 102 emits green light LG. The green light LG emitted from the green light emitting portion 102 travels to the +D2 side along the D2 direction.

The green light emitting portion 102 includes a light source 122 and a pickup element 402. The light sources 122 are supported by a substrate 112. The light source 122 is provided on a plate surface on the +D2 side among plate surfaces of the substrate 112 parallel to a plane including the D1 and D3 directions. A light emitting surface 122e of the light source 122 is disposed substantially parallel to a plane including the D1 and D3 directions, and is a surface opposite to a surface in contact with a plate surface on the +D2 side of the substrate 112 in the light source 122 in the D2 direction.

The light source 122 corresponds to a first light source and emits the green light LG in a green wavelength band in a visible wavelength band. The green wavelength band corresponds to a first wavelength band. The green light LG corresponds to the first light. The green wavelength band is, for example, a wavelength band of 500 nm to 590 nm, and includes, for example, 532 nm.

The light source 122 includes, for example, an LED that emits the green light LG. In the green light emitting portion 102, in order to optimize the red wavelength band and the intensity of the red light LR emitted from the red light emitting portion 101 and the green wavelength band and the intensity of the green light LG with respect to a blue wavelength band and the intensity of the blue light LB emitted from the blue light emitting portion 103, the light source 122 is formed of an LED incorporating a phosphor and includes, for example, an LED main body formed of a semiconductor and a phosphor.

The LED main body is provided on the plate surface on the +D2 side of the substrate 112. The LED main body may be, for example, an LED that emits blue light having a blue wavelength band similarly to the light source 121. The LED main body contains a GaN-based semiconductor material having excellent light extraction efficiency. Since the light source 122 includes the LED main body, the cost of the light source 122 is reduced, and speckle noise of the green light included in the image light IM is reduced.

The phosphor of the light source 122 is stacked on the emission surface on the +D2 side of the LED main body. The phosphor is excited by the light emitted from the LED main body as excitation light, and emits the green light LG as fluorescence from the emission surface. A type and a material of the LED main body and a type and a material of the phosphor are appropriately selected such that the phosphor excited by the light emitted from the LED main body emits the green light LG in the green wavelength band. When the LED main body emits the blue light as described above, the phosphor contains, for example, cerium-doped yttrium aluminum garnet (YAG: Ce³⁺), which is a light transmissive ceramic material.

The green light LG emitted from the light source 122 spreads at a predetermined radiation angle as proceeding from the −D2 side to the +D2 side along the optical axis from the light emitting surface 122e. The spread angle of the green light LG emitted from the light source 122 depends on the radiation angle described above, is within 90°, and is determined by the material of the phosphor of the light source 122. For example, the angle formed by the optical axis parallel to the D2 direction and the light beam of the green light LG spreading most is within 45°.

Similarly to the light source 121, the light source 122 may include one LED, or may include a plurality of LEDs as a whole. When the light source 122 includes a plurality of LEDs, the plurality of LEDs are arranged in a region occupied by the light source 122 in a plane including the D1 and D3 directions.

The substrate 112 is made of, for example, metal, and also acts as a heat dissipation member that receives heat from the light source 122 emitting the green light LG and dissipates the heat to an external space.

The pickup element 402 is provided on the optical path of the green light LG emitted from the light source 122, and is disposed on the +D2 side of the light source 122 and at a position overlapping the light source 122 in the D1 and D3 directions. The pickup element 402 includes, for example, a light guide element 142 and a parallelizing element 162, and corresponds to a first pickup element.

The light guide element 142 is provided on the optical path of the green light LG emitted from the light source 122, and is disposed on the +D2 side of the light source 122 and at a position overlapping the light source 122 in the D1 and D3 directions. The light guide element 142 corresponds to a first light guide element, and includes an incident end 142a on the −D2 side in the D2 direction, an emission end 142b on the +D2 side, and a side surface 142s and a reflection surface 142r extending between the incident end 142a and the emission end 142b in the D2 direction.

The incident end 142a corresponds to a first incident end and spreads parallel to a plane including the D1 and D3 directions. The shape of the incident end 142a viewed in the D2 direction is the same as the shape of the light emitting surface 122e of the light source 122 viewed in the same direction, and is, for example, a quadrangular shape, specifically, a rectangular shape. A size of the light emitting surface 122e of the light source 122 in the D1 and D3 directions is, for example, 0.25 mm or more and 10 mm or less. An area of the light emitting surface 122e of the light source 122 when viewed along the D2 direction is, for example, 0.25 mm×0.25 mm to 10 mm×10 mm.

A size of the incident end 142a in the plane including the D1 and D3 directions may be equal to the size of the light emitting surface 122e of the light source 122 in the plane including the D1 and D3 directions, and is preferably appropriately larger than the size of the light emitting surface 122e in the plane including the D1 and D3 directions. A dimension along the long side parallel to the D1 direction of an opening on which the green light LG is incident at the incident end 142a is 1 mm or more and 3 mm or less, and preferably about 2 mm.

The emission end 142b corresponds to the first emission end, spreads parallel to the plane including the D1 and D3 directions, and is larger than the incident end 142a. The shape of the emission end 142b when viewed from the D2 direction is similar to the modulation surface of the light modulation element 182 when viewed from the same direction, and is, for example, a quadrangular shape. The size of the emission end 142b in the plane including the D1 and D3 directions is equal to the size of the modulation surface of the light modulation element 182 in the plane including the D1 and D3 directions.

A dimension along the long side parallel to the D1 direction of the opening from which the green light LG is emitted at the emission end 142b is 14 mm or more and 16 mm or less, for example, about 15 mm. The size of the modulation surface of the light modulation element 182 may be appropriately selected in a range from 6.48 mm×11.52 mm of a 0.52 inch type to 19.44 mm×34.56 mm of a 1.5 inch type, for example.

The side surface 142s and the reflection surface 142r couple the peripheral edge portion of the incident end 142a and the peripheral edge portion of the emission end 142b in the D2 direction.

The green light LG emitted from the light source 122 is incident on the light guide element 142 from the incident end 142a. In the light guide element 142, an internal space SP2 surrounded by the incident end 142a, the emission end 142b, and the reflection surface 142r is a region through which the green light LG propagates. A size of the internal space SP2 of the light guide element 142 in a plane including the D1 and D3 directions increases as the internal space proceeds from the −D2 side to the +D2 side in the D2 direction.

A cross-sectional area of the emission end 142b of the light guide element 142 that includes the D1 and D3 directions, that is, an area occupied by a cross section of the emission end 142b that is parallel to a plane orthogonal to a central axis of the light guide element 142 that is parallel to the D2 direction is greater than a cross-sectional area of the incident end 142a of the light guide element 142 that includes the same directions, that is, the area occupied by the cross section of the incident end 142a of the light guide element 142 that is parallel to the plane orthogonal to the central axis of the light guide element 142. The area occupied by the cross section orthogonal to the central axis of the light guide element 142 increases as the light guide element 142 extends from the incident end 142a toward the emission end 142b.

A shape of the internal space SP2 of the light guide element 142 in a plane including the D1 and D3 directions changes from the shape of the light emitting surface 122e of the light source 122 when viewed from the D2 direction to the shape of the modulation surface of the light modulation element 182 as the internal space proceeds from the −D2 side toward the +D2 side.

The side surface 142s of the light guide element 142, and the reflection surface 142r provided on the side surface 142s as will be described later, form a predetermined angle with respect to an imaginary line orthogonal to the incident end 142a and the central axis of the light guide element 142, and are separated from the imaginary line in a plane including the D1 and D3 directions as they move from the −D2 side to the +D2 side. The green light LG incident on the light guide element 142 propagates through the internal space SP2 of the light guide element 142 from the −D2 side to the +D2 side.

The modulation surface of the light modulation element 182 has a rectangular shape when viewed along the D2 direction, and the light emitting surface 122e of the light source 122 has a rectangular shape when viewed along the D2 direction. A predetermined angle, that is, a taper angle formed by the side surface 142s including the short side parallel to the D3 direction of the rectangular shape and the reflection surface 142r with respect to the imaginary line and the central axis of the light guide element 142 is, for example, in a range of 7° or more and 22° or less. A predetermined angle, that is, a taper angle formed by the side surface 142s including the long side parallel to the D1 direction of the rectangular shape and the reflection surface 142r with respect to the imaginary line and the central axis of the light guide element 142 is, for example, in a range of 14° or more and 36° or less. A preferable range of the taper angle is appropriately set such that a reflection film 252 of the light guide element 142 has a desired reflectance by numerical simulation based on a configuration of the green light emitting portion 102 and light beam tracing.

The light beams of part of the green light LG incident on the light guide element 142 form an angle smaller than the predetermined taper angle with respect to the imaginary line and the central axis of the light guide element 142, and directly propagate from the incident end 142a to the emission end 142b without being incident even once on the reflection surfaces 142r. A remaining part of the light beams of the green light LG incident on the light guide element 142 forms an angle equal to or greater than the predetermined taper angle with respect to the imaginary line and the central axis of the light guide element 142, are incident on the reflection surface 142r via the incident end 142a once, is reflected by the reflection surface 142r, and then reaches the emission end 142b. Light beams other than the remaining part of the light beams of the green light LG incident on the light guide element 142 are incident on the reflection surface 142r from the incident end 142a twice or more times, are repeatedly reflected by the reflection surface 142r, and then reach the emission end 142b.

The path of the light beam of the green light LG in the internal space SP2 of the light guide element 142 varies depending on an incident angle to the incident end 142a, and extends to a plurality of paths having different numbers of reflections on the reflection surface 142r. Therefore, the illuminance distribution of the green light LG propagating through the internal space SP2 of the light guide element 142 is homogenized in a plane including the D1 and D3 directions. That is, the light guide element 142 homogenizes the illuminance distribution of the incident green light LG in the plane including the D1 and D3 directions. The green light LG having a uniform illuminance distribution is emitted from the emission end 142b to the +D2 side.

The light guide element 142 takes the green light LG into the internal space SP2 from the incident end 142a, guides the green light LG to the +D2 side, and emits the green light LG from the emission end 142b, thereby reducing the spread angle of the green light LG emitted from the light source 122. The spread angle of the green light LG emitted from the light guide element 142 with respect to the optical axis is, for example, within a range of 5° to 30° as an angle formed by the optical axis parallel to the D2 direction and the light beam of the green light LG which spreads most, and is sufficiently smaller than the spread angle of the green light LG emitted from the light source 122 toward the light guide element 142.

Similarly to the light guide element 141, the light guide element 142 is, for example, a hollow reflector formed of a plate-shaped member. The light guide element 142 is formed, for example, in a quadrangular shape when viewed along the D2 direction, and is tapered from the emission end 142b toward the incident end 142a. When viewed along the D2 direction, an end of the reflector frame on the −D2 side has a shape and a size same as those of the incident end 142a and the light emitting surface 122e of the light source 122, and is formed in, for example, a quadrangular shape. An end of the reflector frame on the +D2 side has a shape and a size same as those of the emission end 142b and the modulation surface of the light modulation element 182, and is formed in, for example, a quadrangular shape having a size different from the end on the −D2 side.

The light guide element 142 includes, a plate-shaped member and the reflection film 252. The light guide element 142 includes, for example, four plate-shaped members. The configuration of the light guide element 142 will be described in more detail later.

In the reflector of the light guide element 142 as well, in order to enhance the reflectance of the green light LG incident on the light guide element 142 from the incident end 142a in the vicinity of the side surface 142s, the reflection film 252 such as the dielectric multilayer film is provided on a plate surface opposite to the side surface 142s in the plate-shaped member constituting the reflector, that is, the plate surface facing the internal space SP2 of the light guide element 142. A part of light beams of the green light LG including the light beams incident on the internal space SP2 of the light guide element 142 from the incident end 142a is reflected by the reflection film 252 and travels to the +D2 side.

The intensity of the green light LG reflected by the reflection film 252 and emitted from the reflection film 252 may depend on the incident angle of the green light LG incident on the reflection film 252. When the reflection film 252 is formed of a dielectric multilayer film, for example, incident angle dependency of the intensity of the green light LG emitted from the reflection film 252 changes depending on parameters such as the number of layers of each of a low refractive index layer and a high refractive index layer constituting the dielectric multilayer film, a refractive index of the low refractive index layer, a refractive index of the high refractive index layer, and a refractive index difference between the low refractive index layer and the high refractive index layer. When the reflection film 252 is formed of a metal film, for example, the incident angle dependency of the intensity of the green light LG emitted from the reflection film 252 changes depending on a parameter such as the density of the metal particles.

For example, since a wavelength at which the reflectance is maximized also at a spectral reflectance of the reflection film 252 is a wavelength at which human visibility is maximized, the visibility of the image projected by the projector 350 is enhanced. By adjusting the parameters of the dielectric multilayer film or the metal film constituting the reflection film 252, the wavelength at which the reflectance of the reflection film 252 is maximized can be favorably controlled.

In the light guide element 142, for example, when the taper angle of the light guide element 142 is in a range of 7° or more and 22° or less or in a range of 14° or more and 36° or less, the reflection film 252 is designed such that the incident angle of the green light LG at which the intensity of the green light LG emitted from the reflection surface 142r and the reflection film 252 is the highest is in a predetermined angle range, and parameters of the dielectric multilayer film are appropriately determined. The predetermined angle range is, for example, 60° to 90°. The relationship between the incident angle of the green light LG on the reflection film 252 and the intensity of the green light LG emitted from the reflection film 252 is also obtained by numerical simulation based on the configuration of the green light emitting portion 102 and light beam tracing.

The parallelizing element 162 is provided on the optical path of the green light LG emitted from the light guide element 142, and is disposed on the +D2 side of the light guide element 142 and at a position overlapping the light guide element 142 in the D1 and D3 directions. The parallelizing element 162 parallelizes the green light LG emitted from the light guide element 142 along the D2 direction. The parallelizing element 162 corresponds to the first parallelizing element.

The parallelizing element 162 parallelizes the incident green light LG to reduce the spread angle of the green light LG emitted from the light guide element 142 and reduce at least the spread angle of the green light LG emitted from the light source 122. The spread angle of the green light LG emitted from the parallelizing element 162 with respect to the optical axis is, for example, within a range of 0° to 15° as an angle formed by the optical axis parallel to the D2 direction and the light beam of the green light LG which spreads most, and is further smaller than the spread angle of the green light LG emitted from the light guide element 142 toward the parallelizing element 162, and as a result, is smaller than the spread angle of the green light LG emitted from the light source 122 toward the light guide element 142.

The parallelizing element 162 is, for example, a planoconvex lens, and has an incident surface formed of a flat surface orthogonal to the D2 direction and an emission surface formed of a convex curved surface protruding to an emission side of the green light LG. A focal point of the planoconvex lens constituting the parallelizing element 162 is at least on the −D2 side with respect to the parallelizing element 162, on the side opposite to the +D2 side on which the green light LG is emitted from the parallelizing element 162, and further on the −D2 side with respect to the light guide element 142.

The incident surface of the parallelizing element 162 is in contact with the emission end 142b of the light guide element 142. Since the parallelizing element 162 is in contact with the emission end 142b, the green light LG emitted from the emission end 142b of the light guide element 142 is efficiently taken into the parallelizing element 162, and the loss of the green light LG can be reduced. However, the parallelizing element 162 may be an optical lens other than the planoconvex lens capable of parallelizing the incident green light LG, and may be disposed at an appropriate interval from the light guide element 142 in the D2 direction.

The light-incident-side polarization element 172 is provided on the optical path of the green light LG emitted from the parallelizing element 162, and is disposed at a position closer to the +D2 side than the parallelizing element 162 and overlapping the parallelizing element 162 in the D1 and D3 directions. For example, the light-incident-side polarization element 172 is in contact with the light modulation element 182 from the −D2 side, and may be disposed at an appropriate interval from the light modulation element 182 in the D2 direction. The light-incident-side polarization element 172 emits the predetermined polarized light of the green light LG emitted from the parallelizing element 162 to the +D2 side along the D2 direction. The predetermined polarized light is, for example, the P-polarized light.

The light-incident-side polarization element 172 is, for example, a reflective polarization plate or an absorptive polarization plate having a plate surface parallel to a plane including the D1 and D3 directions. The light-incident-side polarization element 172 transmits a part including the predetermined polarized light of the incident green light LG to the +D2 side, and reflects or absorbs other parts of the green light LG to the −D2 side.

When it is desired to prevent generation of return light and stray light to the light source 122, the light-incident-side polarization element 172 is preferably an absorptive polarization plate. However, when the light source 122 includes a phosphor as in the green light emitting portion 102, the light reflected from the reflective polarization plate can be used for exciting the phosphor, and thus the light-incident-side polarization element 172 may be a reflective polarization plate.

The green light LG emitted from the light source 122 is randomly polarized light including at least the P-polarized light and the S-polarized light. The green light LG emitted from the light source 122 and including the S-polarized light component and the P-polarized light component passes through the light guide element 142, has the illuminance distribution homogenized in a plane including the D1 and D3 directions by the light guide element 142, and is emitted to the +D2 side of the light guide element 142. The green light LG passes through the parallelizing element 162 and is parallelized by the parallelizing element 162.

The parallelized green light LG is incident on the light-incident-side polarization element 172 from the −D2 side. The P-polarized light component of the green light LG is transmitted through the light-incident-side polarization element 172 and is emitted to the +D2 side of the light-incident-side polarization element 172. The S-polarized light component of the green light LG is reflected by the incident surface of the light-incident-side polarization element 172, and is emitted to the −D2 side of the light-incident-side polarization element 172 or is absorbed by the light-incident-side polarization element 172.

The green light LG reflected from the light-incident-side polarization element 172 to the −D2 side sequentially passes through the parallelizing element 162 and the light guide element 142, travels to the −D2 side along the D2 direction, is condensed in a plane including the D1 and D3 directions, and is incident on the phosphor of the light source 122 from the +D2 side. The phosphor is re-excited by the S-polarized light component of the green light LG emitted from the light-incident-side polarization element 172 to the −D2 side, and emits the green light LG including the S-polarized light component and the P-polarized light component from the emission surface of the phosphor to the +D2 side again.

Since the light-incident-side polarization element 172 is formed of the reflective polarization plate, the polarized light of the green light LG that does not pass through the light-incident-side polarization element 172 is incident on the phosphor of the light source 122 again, and contributes to excitation and light emission of the phosphor.

The light modulation element 182 is provided on the optical path of the green light LG emitted from the light-incident-side polarization element 172, and is disposed at a position closer to the +D2 side than the light-incident-side polarization element 172 and overlapping the light-incident-side polarization element 172 in the D1 and D3 directions. The light modulation element 182 corresponds to the first light modulation element, and modulates the green light LG emitted from the light-incident-side polarization element 172 based on image information transmitted from an image forming device such as a computer (not shown) coupled to the light modulation element 182 from the outside.

The light modulation element 182 is, for example, a transmissive liquid crystal panel. The liquid crystal panel constituting the light modulation element 182 has a plurality of pixels (not shown). The pixels each include a switching element. The switching element is, for example, a TFT. An electric signal corresponding to the brightness of the green light at a relative position of each of the pixels on the modulation surface of the light modulation element 182 in an image projected by the projector 350 is supplied to the switching element of each of the pixels. Each of the pixels modulates a vibration direction of the green light LG incident from the light-incident-side polarization element 172 by an operation of the switching element according to the electric signal described above to generate green image light IG. The image light IG corresponds to the first light. The light modulation element 182 emits the image light IG generated by the liquid crystal panel toward the +D2 side along the D2 direction.

The light-emission-side polarization element 176 is provided on an optical path of the image light IG emitted from the light modulation element 182, and is disposed at a position closer to the +D2 side than the light modulation element 182 and overlapping the light modulation element 182 in the D1 and D3 directions. For example, the light-emission-side polarization element 176 is in contact with the light modulation element 182 from the +D2 side, and may be disposed at an appropriate interval from the light modulation element 182 in the D2 direction. The light-emission-side polarization element 176 emits the predetermined polarized light of the image light IG emitted from the light modulation element 182 to the +D2 side along the D2 direction. The predetermined polarized light is, for example, the P-polarized light.

The light-emission-side polarization element 176 is, for example, a reflective polarization plate or an absorptive polarization plate having a plate surface parallel to a plane including the D1 and D3 directions. The light-emission-side polarization element 176 transmits a part including the predetermined polarized light of the incident image light IG to the +D2 side, and reflects or absorbs other parts of the image light IG to the −D2 side. When it is desired to reduce the generation of return light and stray light to the light modulation element 182, it is desirable to adopt the absorptive polarization plate as the light-emission-side polarization element 176.

The blue light emitting portion 103 is disposed on the +D1 side of the green light emitting portion 102 and is disposed in a region overlapping the red light emitting portion 101 in the D2 and D3 directions. The blue light emitting portion 103 emits the blue light LB. The blue light LB emitted from the blue light emitting portion 103 travels to the −D1 side along the D1 direction.

The blue light emitting portion 103 includes a light source 123 and a pickup element 403. The light source 123 are supported by a substrate 113. The light source 123 is provided at a −D1-side plate surface of the substrate 113 among plate surfaces of the substrate 113 that are parallel to a plane including the D2 and D3 directions. A light emitting surface of the light source 123 is disposed substantially in parallel to the plane including the D2 and D3 directions, and is a surface opposite in the D1 direction to the surface of the light source 123 that is in contact with the −D1-side plate surface of the substrate 113. The light source 123 corresponds to a third light source and emits the blue light LB in a blue wavelength band in a visible wavelength band. The blue wavelength band is, for example, a wavelength band of 430 nm to 500 nm, and includes, for example, 467 nm.

The light source 123 is implemented, for example, with an LED that emits the blue light LB. The LED that emits the blue light LB contains a gallium nitride (GaN)-based semiconductor material having excellent light extraction efficiency as a light emitter.

The blue light LB emitted from the light source 123 spreads at a predetermined radiation angle as proceeding from the +D1 side toward the −D1 side along the optical axis from the light emitting surface. A spread angle of the blue light LB emitted from the light source 123 depends on the radiation angle described above, is within 90°, and is determined by a material of the light source 123. For example, an angle formed by the optical axis parallel to the D1 direction and a light beam of the blue light LB that spreads most is within 45°.

The light source 123 may include one LED or a plurality of LEDs as a whole. When the light source 123 includes a plurality of LEDs, the plurality of LEDs are arranged in a region occupied by the light source 123 in a plane including the D2 and D3 directions.

By using the LED as the light source 123, cost of the light source 123 is reduced, and speckle noise of the blue light included in the image light IM projected on a screen SCR is reduced.

The substrate 113 is made of, for example, metal, and also acts as a heat dissipation member that receives heat from the light source 123 emitting the blue light LB and dissipates the heat to an external space.

The pickup element 403 is provided on the optical path of the blue light LB emitted from the light source 123, and is disposed on the −D1 side of the light source 123 and at a position overlapping the light source 123 in the D2 and D3 directions. The pickup element 403 includes, for example, a light guide element 143 and a parallelizing element 163, and corresponds to a third pickup element.

The light guide element 143 is provided on the optical path of the blue light LB emitted from the light source 123, and is disposed on the −D1 side of the light source 123 and at a position overlapping the light source 123 in the D2 and D3 directions. The light guide element 143 corresponds to a third light guide element, and includes an incident end 143a on the +D1 side in the D1 direction, an emission end 143b on the −D1 side, and a side surface 143s and a reflection surface 143r extending between the incident end 143a and the emission end 143b in the D1 direction.

The incident end 143a corresponds to a third incident end and spreads in parallel to the plane including the D2 and D3 directions. The shape of the incident end 143a viewed in the D1 direction is the same as the shape of the light emitting surface of the light source 123 viewed in the same direction, and is, for example, a quadrangular shape, specifically, a rectangular shape. The sizes of the light emitting surface of the light source 123 in the D2 and D3 directions are each, for example, 0.25 mm or more and 10 mm or less. The area of the light emitting surface of the light source 123 when viewed along the D1 direction is, for example, 0.25 mmx 0.25 mm to 10 mm×10 mm.

The sizes of the incident end 143a in a plane including the D2 and D3 directions may be equal to the sizes of the light emitting surface of the light source 123 in a plane including the D2 and D3 directions, and are preferably appropriately greater than the sizes of the light emitting surface of the light source 123 in the plane including the D2 and D3 directions. A dimension along a long side parallel to the D2 direction of an opening on which the blue light LB is incident at the incident end 143a is 1 mm or more and 3 mm or less, for example, about 2 mm.

The emission end 143b corresponds to a third emission end, spreads in parallel to a plane including the D2 and D3 directions, and is larger than the incident end 143a. The shape of the emission end 143b viewed in the D1 direction is the same as the shape of the light modulation surface of a light modulation element 183 viewed in the same direction, and is, for example, a quadrangular shape. The sizes of the emission end 143b in a plane including the D2 and D3 directions are equal to the sizes of a modulation surface of the light modulation element 183 in a plane including the D2 and D3 directions.

The dimension along the long side parallel to the D2 direction of the opening from which the blue light LB is emitted at the emission end 143b is 14 mm or more and 16 mm or less, for example, about 15 mm. The size of the modulation surface of the light modulation element 183 in a long side direction, that is, the D2 direction is, for example, 15 mm. The size of the modulation surface of the light modulation element 183 may be appropriately selected in a range from 6.48 mm×11.52 mm of a 0.52 inch type to 19.44 mm×34.56 mm of a 1.5 inch type, for example.

The side surfaces 143s and the reflection surfaces 143r couple a peripheral edge portion of the incident end 143a to a peripheral edge portion of the emission end 143b in the D1 direction.

The blue light LB emitted from the light source 123 is incident on the light guide element 143 from the incident end 143a. In the light guide element 143, an internal space SP3 surrounded by the incident end 143a, the emission end 143b, and the reflection surface 143r is a region in which the blue light LB propagates. A size of the internal space SP3 surrounded by the incident end 143a, the emission end 143b, and the reflection surface 143r in the plane including the D2 and D3 directions increases as proceeding from the +D1 side to the −D1 side in the D1 direction.

A cross-sectional area of the emission end 143b of the light guide element 143 that includes the D2 and D3 directions, that is, an area occupied by a cross section of the emission end 143b that is parallel to a plane orthogonal to a central axis of the light guide element 143 that is parallel to the D1 direction is greater than a cross-sectional area of the incident end 143a of the light guide element 143 that includes the same directions, that is, the area occupied by the cross section of the incident end 143a of the light guide element 143 that is parallel to the plane orthogonal to the central axis of the light guide element 143. The area occupied by the cross section orthogonal to the central axis of the light guide element 143 increases as the light guide element 143 extends from the incident end 143a toward the emission end 143b.

A shape of the internal space SP3 of the light guide element 143 in a plane including the D2 and D3 directions changes from the shape of the light emitting surface of the light source 123 when viewed from the D1 direction to the shape of the modulation surface of the light modulation element 183 as the internal space proceeds from the +D1 side toward the −D1 side.

The side surface 143s of the light guide element 143, and the reflection surface 143r provided on the side surface 143s as will be described later, form a predetermined angle with respect to an imaginary line orthogonal to the incident end 143a and the central axis of the light guide element 143, and are separated from the imaginary line in a plane including the D2 and D3 directions as they move from the +D1 side to the −D1 side. The blue light LB incident on the light guide element 143 propagates through the internal space SP3 surrounded by the incident end 143a, the emission end 143b, and the reflection surface 143r from the +D1 side to the −D1 side.

The modulation surface of the light modulation element 183 has a rectangular shape when viewed along the D1 direction, and the light emitting surface of the light source 123 has a rectangular shape when viewed along the D1 direction. A predetermined angle, that is, a taper angle formed by the side surface 143s including the short side parallel to the D3 direction of the rectangular shape and the reflection surface 143r with respect to the imaginary line and the central axis of the light guide element 143 is, for example, in a range of 7° or more and 22° or less. A predetermined angle, that is, a taper angle formed by the side surface 143s including the long side parallel to the D2 direction of the rectangular shape and the reflection surface 143r with respect to the imaginary line and the central axis of the light guide element 143 is in a range of 14° or more and 36° or less. A preferable range of the taper angle is appropriately set such that a reflection film 253 of the light guide element 143 has a desired spectral reflectance as described later by numerical simulation based on the configuration of the blue light emitting portion 103 and light beam tracing.

A part of the blue light LB incident on the light guide element 143 forms an angle smaller than the predetermined taper angle with respect to the imaginary line and the central axis of the light guide element 143, and directly propagates from the incident end 143a to the emission end 143b without being incident even once on the reflection surfaces 143r. A remaining part of the blue light LB incident on the light guide element 143 forms an angle equal to or greater than the predetermined taper angle with respect to the imaginary line and the central axis of the light guide element 143, is incident on the reflection surface 143r via the incident end 143a once or more times, is reflected by the reflection surface 143r, and then reaches the emission end 143b. The path of the light beam of the blue light LB in the internal space SP3 surrounded by the incident end 143a, the emission end 143b, and the reflection surface 143r varies depending on the incident angle to the incident end 143a, and extends to a plurality of paths having different numbers of reflections on the reflection surface 143r.

The illuminance distribution of the blue light LB propagating through the internal space SP3 of the light guide element 143 is homogenized in a plane including the D2 and D3 directions. That is, the light guide element 143 homogenizes the illuminance distribution of the incident blue light LB in the plane including the D2 and D3 directions. The blue light LB having a uniform illuminance distribution is emitted from the emission end 143b to the −D1 side.

The light guide element 143 takes the blue light LB into the internal space SP3 from the incident end 143a, guides the blue light LB to the −D1 side, and emits the blue light LB from the emission end 143b, thereby reducing the spread angle of the blue light LB emitted from the light source 123. The spread angle of the blue light LB emitted from the light guide element 143 with respect to the optical axis is, for example, within a range of 5° to 30° as an angle formed by the optical axis parallel to the D1 direction and the light beam of the blue light LB which spreads most, and is smaller than the spread angle of the blue light LB emitted from the light source 123 toward the light guide element 143.

Similarly to the light guide elements 141 and 142, the light guide element 143 is, for example, a hollow reflector formed of a plate-shaped member. The light guide element 143 is formed, for example, in a quadrangular shape when viewed along the D1 direction, and is tapered from the emission end 143b toward the incident end 143a. When viewed along the D1 direction, the end of the light guide element 143 on the +D1 side has a shape and a size same as those of the incident end 143a and the light emitting surface of the light source 123, and is formed in, for example, a quadrangular shape. The end of the light guide element 143 on the −D1 side has a shape and a size same as those of the emission end 143b and the modulation surface of the light modulation element 183, and is formed in, for example, a quadrangular shape having a size different from the end on the +D1 side.

The reflector of the light guide element 143 includes four plate-shaped members and the reflection film 253. The light guide element 143 is implemented by the four plate-shaped members each having a trapezoidal shape with the sides corresponding to legs of the trapezoidal shape coupled to each other. A width, that is, a dimension of each of the sides facing the +D1 side that are parallel to the D2 or D3 direction and correspond to upper bases of the four plate-shaped members is set according to the size of the incident end 143a and the light emitting surface of the light source 123 in the D2 or D3 direction. The width, that is, the dimension of each of the sides facing the −D1 side that are parallel to the D2 or D3 direction and correspond to lower bases of the four plate-shaped members is set according to the size of the emission end 143b and the light modulation surface of the light modulation element 183 in the D2 or D3 direction.

In consideration of the size and the like of the light source 123, the width, that is, the dimension of the end side parallel to the D2 direction on the +D1 side of the plate-shaped member of the light guide element 143 is 1 mm or more and 3 mm or less, for example, about 2 mm. The width, that is, the dimension of the end side parallel to the D2 direction on the −D1 side of the plate-shaped member of the light guide element 143 is 14 mm or more and 16 mm or less, for example, about 15 mm. The length in the D1 direction of the plate-shaped member of the light guide element 143 from the incident end 143a to the emission end 143b is, for example, 5 mm or more and 25 mm or less. The shape of the light guide element 143 is the same as the shape of the light guide elements 141 and 142.

The material of the four plate-shaped members of the light guide element 143 includes at least one of Al, Ag, and glass, that is, SiO₂, and is, for example, the same as the material of the plate-shaped members of the light guide elements 141 and 142.

In the reflector of the light guide element 143 as well, in order to enhance the reflectance of the blue light LB incident on the light guide element 143 from the incident end 143a in the vicinity of the side surface 143s, the reflection film 253 made of the dielectric multilayer film and the like is provided on a plate surface opposite to the side surface 143s in the plate-shaped member constituting the reflector, that is, the plate surface facing the internal space SP3 of the light guide element 143. Part of the blue light LB incident on the internal space SP3 of the light guide element 143 from the incident end 143a is reflected by the reflection film 253 and travels to the −D1 side.

An intensity of the blue light LB reflected by the reflection film 253 and emitted from the reflection film 253 may depend on the incident angle of the blue light LB incident on the reflection film 253. When the reflection film 253 is formed of a dielectric multilayer film, for example, incident angle dependency of the intensity of the blue light LB emitted from the reflection film 253 changes depending on parameters such as the number of layers of each of a low refractive index layer and a high refractive index layer constituting the dielectric multilayer film, a refractive index of the low refractive index layer, a refractive index of the high refractive index layer, and a refractive index difference between the low refractive index layer and the high refractive index layer. When the reflection film 253 is formed of a metal film, for example, the incident angle dependency of the intensity of the blue light LB emitted from the reflection film 253 changes depending on a parameter such as the density of the metal particles.

Since a wavelength at which the reflectance is maximized also at a spectral reflectance of the reflection film 253 is a wavelength at which human visibility is maximized, the visibility of the image projected by the projector 350 is enhanced. By adjusting the parameters of the dielectric multilayer film or the metal film constituting the reflection film 253, the wavelength at which the reflectance of the reflection film 253 is maximized is effectively controlled.

As described above, for example, when the taper angle of the light guide element 143 is in a range of 7° or more and 22° or less or in a range of 140 or more and 36° or less, the reflection film 253 is designed such that the incident angle of the blue light LB at which the intensity of the blue light LB emitted from the reflection surface 143r and the reflection film 253 is the highest is in a predetermined angle range, and parameters of the dielectric multilayer film are appropriately determined. The predetermined angle range is, for example, 60° to 90°. The relationship between the incident angle of the blue light LB on the reflection film 253 and the intensity of the blue light LB emitted from the reflection film 253 is also obtained by numerical simulation based on the configuration of the blue light emitting portion 103 and light beam tracing.

The parallelizing element 163 is provided in the optical path of the blue light LB emitted from the light guide element 143, and is disposed at a position which is shifted toward the −D1 side from the light guide element 143 and where the parallelizing element 163 overlaps the light guide element 143 in the D2 and D3 directions. The parallelizing element 163 parallelizes the blue light LB emitted from the light guide element 143 along the D1 direction. The parallelizing element 163 corresponds to a third parallelizing element.

The parallelizing element 163 parallelizes the incident blue light LB to reduce the spread angle of the blue light LB emitted from the light guide element 143 and reduce at least the spread angle of the blue light LB emitted from the light source 123. The spread angle of the blue light LB emitted from the parallelizing element 163 with respect to the optical axis is, for example, within a range of 0° to 15° as an angle formed by the optical axis parallel to the D1 direction and the light beam of the blue light LB which spreads most, and is further smaller than the spread angle of the blue light LB emitted from the light guide element 143 toward the parallelizing element 163, and as a result, is smaller than the spread angle of the blue light LB emitted from the light source 123 toward the light guide element 143.

The parallelizing element 163 is, for example, a planoconvex lens, and has an incident surface formed of a flat surface orthogonal to the D1 direction and an emission surface formed of a convex curved surface protruding to an emission side of the blue light LB. A focal point of the planoconvex lens constituting the parallelizing element 163 is at least on the +D1 side with respect to the parallelizing element 163, on the side opposite to the −D1 side on which the blue light LB is emitted from the parallelizing element 163, and further on the +D1 side with respect to the light guide element 143.

The incident surface of the parallelizing element 163 is in contact with the emission end 143b of the light guide element 143. Since the parallelizing element 163 is in contact with the emission end 143b, the blue light LB emitted from the emission end 143b of the light guide element 143 is efficiently taken into the parallelizing element 163, and loss of the blue light LB can be reduced. However, the parallelizing element 163 may be an optical lens other than the planoconvex lens capable of parallelizing the incident blue light LB, and may be disposed at an appropriate interval from the light guide element 143 in the D1 direction.

The light-incident-side polarization element 173 is provided on the optical path of the blue light LB emitted from the parallelizing element 163, and is disposed at a position closer to the −D1 side than the parallelizing element 163 and overlapping the parallelizing element 163 in the D2 and D3 directions. For example, the light-incident-side polarization element 173 is in contact with the light modulation element 183 from the +D1 side, and may be disposed at an appropriate interval from the light modulation element 183 in the D1 direction.

The light-incident-side polarization element 173 emits predetermined polarized light of the blue light LB emitted from the parallelizing element 163 to the −D1 side along the D1 direction. The predetermined polarized light is, for example, S-polarized light. The light-incident-side polarization element 173 is, for example, a reflective polarization plate or an absorptive polarization plate having a plate surface parallel to a plane including the D2 and D3 directions. The light-incident-side polarization element 173 transmits a part including the predetermined polarized light of the incident blue light LB to the −D1 side, and reflects or absorbs other parts of the blue light LB to the +D1 side. When it is desired to prevent generation of return light and stray light to the light source 123, the light-incident-side polarization element 173 is preferably an absorptive polarization plate.

The blue light LB emitted from the light source 123 includes at least P-polarized light and S-polarized light, and is, for example, randomly polarized light. An S-polarized light component of the blue light LB emitted from the light source 123 sequentially passes through the light guide element 143 and the parallelizing element 163 as described above, is transmitted through the light-incident-side polarization element 173, and is emitted to the −D1 side of the light-incident-side polarization element 173. Similarly to the S-polarized light component, a P-polarized light component of the blue light LB sequentially passes through the light guide element 143 and the parallelizing element 163, is reflected by the incident surface of the light-incident-side polarization element 173, and is emitted to the +D1 side of the light-incident-side polarization element 173 or is absorbed by the light-incident-side polarization element 173.

The light modulation element 183 is provided on the optical path of the blue light LB emitted from the light-incident-side polarization element 173, and is disposed at a position closer to the −D1 side than the light-incident-side polarization element 173 and overlapping the light-incident-side polarization element 173 in the D2 and D3 directions. The light modulation element 183 corresponds to a third light modulation element, and modulates the blue light LB emitted from the light-incident-side polarization element 173 based on image information transmitted from an image forming device such as a computer (not shown) coupled to the light modulation element 183 from the outside.

The light modulation element 183 is, for example, a transmissive liquid crystal panel. The liquid crystal panel constituting the light modulation element 183 has a plurality of pixels (not shown). The pixels each include a switching element. The switching element is, for example, a TFT. An electric signal corresponding to the brightness of the blue light at a relative position of each of the pixels on the modulation surface of the light modulation element 183 in an image projected by the projector 350 is supplied to the switching element of each of the pixels. Each of the pixels modulates a vibration direction of the blue light LB incident from the light-incident-side polarization element 173 by an operation of the switching element according to the electric signal described above to generate blue image light IB. The image light IB corresponds to third light. The light modulation element 183 emits the image light IB generated by the liquid crystal panel toward the −D1 side along the D1 direction.

The light-emission-side polarization element 177 is provided on an optical path of the image light IB emitted from the light modulation element 183, and is disposed at a position closer to the −D1 side than the light modulation element 183 and overlapping the light modulation element 183 in the D2 and D3 directions. For example, the light-emission-side polarization element 177 is in contact with the light modulation element 183 from the −D1 side, and may be disposed at an appropriate interval from the light modulation element 183 in the D1 direction. The light-emission-side polarization element 177 emits the predetermined polarized light of the image light IB emitted from the light modulation element 183 to the −D1 side along the D1 direction. The predetermined polarized light is, for example, S-polarized light.

The light-emission-side polarization element 177 is, for example, a reflective polarization plate or an absorptive polarization plate having a plate surface parallel to a plane including the D2 and D3 directions. The light-emission-side polarization element 177 transmits a part including the predetermined polarized light of the incident image light IB to the −D1 side, and reflects or absorbs other parts of the image light IB to the +D1 side. When it is desired to prevent generation of return light and stray light to the light modulation element 183, the light-emission-side polarization element 177 is preferably an absorptive polarization plate.

The light combining element 200 is disposed in a region where the optical path of the red image light IR emitted from the light-emission-side polarization element 175, the optical path of the green image light IG emitted from the light-emission-side polarization element 176, and the optical path of the blue image light IB emitted from the light-emission-side polarization element 177 intersect each other. The light combining element 200 combines the image light IR, IG, and IB emitted from the light-emission-side polarization elements 175, 176, and 177 and emits the combined light to the +D2 side along the D2 direction.

The light combining element 200 is, for example, a cross dichroic prism 210. The cross dichroic prism 210 has an incident surface 210c facing the emission surface of the light-emission-side polarization element 175, an incident surface 210d facing the emission surface of the light-emission-side polarization element 176, an incident surface 210e facing the emission surface of the light-emission-side polarization element 177, an emission surface 210b, and two reflection films 211 and 212. The incident surfaces 210c and 210e are parallel to a plane including the D2 and D3 directions, and overlap each other in the D2 and D3 directions. The incident surface 210d and the emission surface 210b are parallel to a plane including the D1 and D3 directions and overlap each other in the D1 and D3 directions.

The reflection film 211 is disposed to move from the +D2 side to the −D2 side as moving from the −D1 side to the +D1 side when viewed along the D3 direction. The reflection film 212 is disposed to move from the −D2 side to the +D2 side as moving from the −D1 side to the +D1 side when viewed along the D3 direction. The reflection films 211 and 212 overlap the incident surfaces 210c and 210e in the D2 direction and overlaps the emission surface 210b and the incident surface 210d in the D3 direction.

The reflection film 211 reflects light in the blue wavelength band and transmits light in the green wavelength band and the red wavelength band. The reflection film 212 corresponds to a first reflection film, and reflects light in the red wavelength band and transmits light in the blue wavelength band and the green wavelength band. The reflection films 211 and 212 are formed of, for example, a dielectric multilayer film.

The cross dichroic prism 210 is implemented such that four right-angled prisms are bonded to each other at their right-angled constituent surfaces with their right-angled vertices aligned with a center position of the light combining element 200 when viewed from the D3 direction. The four right-angled prisms of the cross dichroic prism 210 are formed of a transparent material that transmits light of a visible wavelength band.

The reflection film 211 is disposed on the right-angled constituent surface that moves from the +D2 side to the −D2 side as it moves from the −D1 side to the +D1 side as described above among the right-angled constituent surfaces of the four right-angled prisms, and is formed of, for example, a dielectric multilayer film. The reflection film 212 is disposed at the right-angled constituent surface that extends from the −D2 side toward the +D2 side as extending from the −D1 side toward the +D1 side as described above among the right-angled constituent surfaces of the four right-angled prisms.

The S-polarized light of the red image light IR emitted from the light-emission-side polarization element 175 is incident on the inside of the cross dichroic prism 210 from the incident surface 210c to the +D1 side along the D1 direction, is transmitted through the reflection film 211, is reflected by the reflection film 212, and travels to the +D2 side. The P-polarized light of the green image light IG emitted from the light-emission-side polarization element 176 is incident on the inside of the cross dichroic prism 210 from the incident surface 210d to the +D2 side along the D2 direction, is transmitted through the reflection films 211 and 212, and travels straight to the +D2 side. The S-polarized light of the blue image light IB emitted from the light-emission-side polarization element 177 is incident on the inside of the cross dichroic prism 210 from the incident surface 210e to the −D1 side along the D1 direction, is transmitted through the reflection film 212, is reflected by the reflection film 211, and travels to the +D2 side.

The image light IB, IG, and IR emitted from the reflection films 211 and 212 of the cross dichroic prism 210 to the +D2 side are combined with each other, and full-color image light IM is generated. The cross dichroic prism 210 emits the full-color image light IM from the emission surface 210b to the +D2 side along the D2 direction.

The projection optical system 320 is disposed on the optical path of the image light IM emitted from the light combining element 200. The projection optical system 320 projects the image light IM emitted from the light combining element 200 onto the screen SCR disposed on the +D2 side, and enlarges and displays the image transmitted from the image forming device to the light modulation elements 181, 182, and 183 on the screen SCR.

The projection optical system 320 includes, for example, one or more optical lenses arranged along the D2 direction. Examples of the optical lens include a planoconvex lens, a planoconcave lens, a biconvex lens, a biconcave lens, a meniscus lens, an aspherical lens, and a free-form lens.

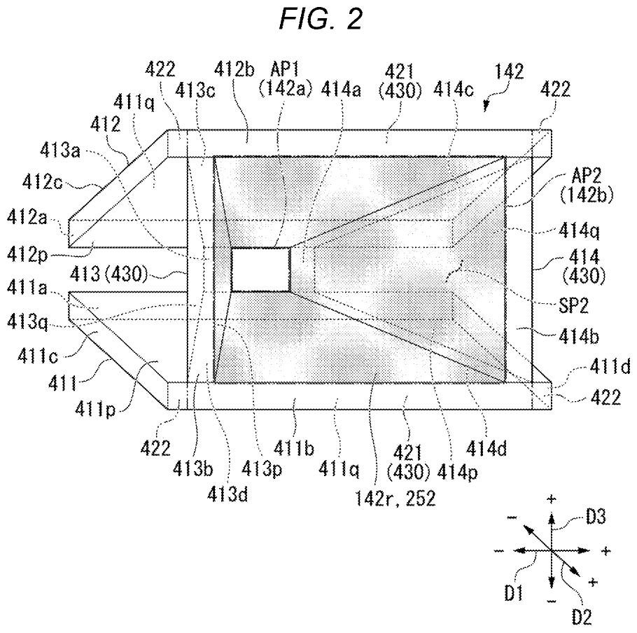

Next, a configuration example of the light guide elements 141, 142, and 143 will be described with reference to the drawings. FIG. 2 is a perspective view of the light guide element 142. As shown in FIG. 2, the light guide element 142 includes four plate-shaped members as described above, and includes, for example, four plate-shaped members 411, 412, 413, and 414. The plate-shaped member 411 corresponds to a third light guide plate. The plate-shaped member 412 corresponds to a first light guide plate. The plate-shaped member 414 corresponds to a second light guide plate. The plate-shaped member 413 corresponds to a fourth light guide plate.

The plate-shaped members 411 and 412 have the same shape. The plate-shaped member 411 has two plate surfaces 411p and 411q, two end surfaces 411a and 411b, and two side surfaces 411c and 411d. The plate-shaped member 412 is disposed on a +D3 side of the plate-shaped member 411, and has two plate surfaces 412p and 412q, two end surfaces 412a and 412b, and two side surfaces 412c and 412d.

The plate surface 411p of the plate-shaped member 411 is located on the +D3 side among the two plate surfaces of the plate-shaped member 411. The plate surface 411q of the plate-shaped member 411 is located on a −D3 side among the two plate surfaces of the plate-shaped member 411 and is parallel to the plate surface 411p. At least a central region of the plate surface 411p faces the internal space SP2. The plate surfaces 411p and 411q have a substantially square shape when viewed from a direction (not shown) orthogonal to each of the plate surfaces. A pair of sides parallel to each other among two sets of sides of each of the plate surfaces 411p and 411q is parallel to the D1 direction. Another pair of sides parallel to each other among the two sets of pairs of sides of each of the plate surfaces 411p and 411q moves from the +D3 side to the −D3 side as proceeding from the −D2 side to the +D2 side. That is, when viewed along the D1 direction, the plate surfaces 411p and 411q move from the +D3 side to the −D3 side as proceeding from the −D2 side to the +D2 side.

The end surface 411a of the plate-shaped member 411 is located on the −D2 side of the two end surfaces of the plate-shaped member 411. The end surface 411b of the plate-shaped member 411 is located on the +D2 side of the two end surfaces of the plate-shaped member 411 and is parallel to the end surface 411a. The end surfaces 411a and 411b have a rectangular shape when viewed from a direction (not shown) orthogonal to each of the plate surfaces. The long side of each of the end surfaces 411a and 411b is parallel to the D1 direction. The short sides of the end surfaces 411a and 411b may slightly move from the −D2 side to the +D2 side as proceeding from the −D3 side to the +D3 side, and are preferably parallel to the D3 direction. That is, the end surfaces 411a and 411b are substantially parallel to a plane including the D1 and D3 directions.

The side surface 411c of the plate-shaped member 411 is located on the −D1 side of the two side surfaces of the plate-shaped member 411. The side surface 411d of the plate-shaped member 411 is located on the +D1 side of the two side surfaces of the plate-shaped member 411 and is parallel to the side surface 411c. The side surfaces 411c and 411d have a rectangular shape when viewed from a direction (not shown) orthogonal to each of the plate surfaces. The long side of each of the side surfaces 411c and 411d moves from the +D3 side to the −D3 side as proceeding from the −D2 side to the +D2 side. The short side of each of the side surfaces 411c and 411d are parallel to the D3 direction. That is, when viewed along the D1 direction, the side surfaces 411c and 411d move from the +D3 side to the −D3 side as proceeding from the −D2 side to the +D2 side.

The plate surface 412p of the plate-shaped member 412 is located on the −D3 side among the two plate surfaces of the plate-shaped member 412. The plate surface 412q of the plate-shaped member 412 is located on the +D3 side among the two plate surfaces of the plate-shaped member 412 and is parallel to the plate surface 412p. At least a central region of the plate surface 412p faces the internal space SP2. The plate surfaces 412p and 412q have a substantially square shape when viewed from a direction (not shown) orthogonal to each of the plate surfaces, and have the same shape as the shape when viewed from a direction (not shown) orthogonal to each of the plate surfaces of the plate surfaces 411p and 411q. A pair of sides parallel to each other among two sets of sides of each of the plate surfaces 412p and 412q is parallel to the D1 direction. Another pair of sides parallel to each other among the two sets of pairs of sides of each of the plate surfaces 412p and 412q moves from the −D3 side to the +D3 side as proceeding from the −D2 side to the +D2 side. That is, when viewed along the D1 direction, the plate surfaces 412p and 412q move from the −D3 side to the +D3 side as proceeding from the −D2 side to the +D2 side.

The end surface 412a of the plate-shaped member 412 is located on the −D2 side of the two end surfaces of the plate-shaped member 412. The end surface 412b of the plate-shaped member 412 is located on the +D2 side of the two end surfaces of the plate-shaped member 412 and is parallel to the end surface 412a. The end surfaces 412a and 412b have a rectangular shape when viewed from a direction (not shown) orthogonal to each of the plate surfaces. The long side of each of the end surfaces 412a and 412b is parallel to the D1 direction. The short side of each of the end surfaces 412a and 412b may move from the +D2 side to the −D2 side as proceeding from the −D3 side to the +D3 side, and is preferably parallel to the D3 direction. That is, the end surfaces 412a and 412b are substantially parallel to a plane including the D1 and D3 directions.

The side surface 412c of the plate-shaped member 412 is located on the −D1 side of the two side surfaces of the plate-shaped member 412. The side surface 412d of the plate-shaped member 412 is located on the +D1 side of the two side surfaces of the plate-shaped member 412 and is parallel to the side surface 412c. The side surfaces 412c and 412d have a rectangular shape when viewed from a direction (not shown) orthogonal to each of the plate surfaces. The long side of each of the side surfaces 412c and 412d moves from the −D3 side to the +D3 side as proceeding from the −D2 side to the +D2 side. The short side of each of the side surfaces 412c and 412d are parallel to the D3 direction. That is, when viewed along the D1 direction, the side surfaces 412c and 412d move from the −D3 side to the +D3 side as proceeding from the −D2 side to the +D2 side.

The plate-shaped member 413 has two plate surfaces 413p and 413q, two end surfaces 413a and 413b, and two side surfaces 413c and 413d. The plate-shaped member 414 is disposed on the +D1 side of the plate-shaped member 413, and has two plate surfaces 414p and 414q, two end surfaces 414a and 414b, and two side surfaces 414c and 414d.

The plate surface 413p of the plate-shaped member 413 is located on the +D1 side among the two plate surfaces of the plate-shaped member 413. The plate surface 413q of the plate-shaped member 413 is located on the −D1 side among the two plate surfaces of the plate-shaped member 413 and is parallel to the plate surface 413p. The entire region of the plate surface 413p faces the internal space SP2. The plate surfaces 413p and 413q have a trapezoidal shape when viewed from a direction (not shown) orthogonal to each of the plate surfaces.

The sides corresponding to the parallel upper bases of the plate surfaces 413p and 413q of the plate-shaped member 413 are parallel to the D3 direction. The dimensions of the sides corresponding to the upper bases of the plate surfaces 413p and 413q are set based on design conditions and a relative relationship to be described later according to the sizes of the incident end 142a and the light emitting surface 122e of the light source 122 in the D3 direction. The sides corresponding to lower bases parallel to each other of the plate surfaces 413p and 413q of the plate-shaped member 413 are located further towards the −D1 side and the +D2 side than the sides corresponding to the upper bases of the plate surfaces 413p and 413q, and are parallel to the D3 direction. The dimensions of the sides corresponding to the lower bases of the plate surfaces 413p and 413q are set based on design conditions and a relative relationship described later according to the sizes of the emission end 142b and the modulation surface of the light modulation element 182 in the D3 direction.

The sides corresponding to a pair of legs of each of the plate surfaces 413p and 413q move from the +D1 side to the −D1 side as proceeding from the −D2 side to the +D2 side. The side corresponding to the leg located on the −D3 side of each of the plate surfaces 413p and 413q moves from the +D3 side to the −D3 side as proceeding from the −D2 side to the +D2 side. The side corresponding to the leg located on the +D3 side of each of the plate surfaces 413p and 413q moves from the −D3 side to the +D3 side as proceeding from the −D2 side to the +D2 side. That is, when viewed along the D1 direction, the plate surfaces 413p and 413q move from the +D1 side to the −D1 side as proceeding from the −D2 side to the +D2 side, and the dimension of each of the plate surfaces 413p and 413q in the D3 direction increases as proceeding from the −D2 side to the +D2 side.

The end surface 413a of the plate-shaped member 413 is located on the +D1 side and the −D2 side of the two end surfaces of the plate-shaped member 413. The end surface 413b of the plate-shaped member 413 is located on the −D1 side and the +D2 side of the two end surfaces of the plate-shaped member 413, and is parallel to the end surface 413a. The end surfaces 413a and 413b have a rectangular shape when viewed from a direction (not shown) orthogonal to each of the plate surfaces. The long sides of each of the end surfaces 413a and 413b are parallel to the D3 direction. A dimension of the long side of the end surface 413a in the D3 direction is equal to a dimension of the incident end 142a of the light guide element 142 in the D3 direction. A dimension of the long side of the end surface 413b in the D3 direction is equal to a dimension of the emission end 142b of the light guide element 142 in the D3 direction. The short side of each of the end surfaces 413a and 413b may move from the −D2 side to the +D2 side as proceeding from the −D1 side to the +D1 side, and is preferably parallel to the D3 direction. That is, the end surfaces 413a and 413b are substantially parallel to a plane including the D1 and D3 directions.

The side surface 413c of the plate-shaped member 413 is located on the +D3 side among the two side surfaces of the plate-shaped member 413. The side surface 413d of the plate-shaped member 413 is located on the −D3 side among the two side surfaces of the plate-shaped member 413. The side surfaces 413c and 413d have a rectangular shape when viewed from a direction (not shown) orthogonal to each of the plate surfaces. The long side of the side surface 413c moves from the −D3 side to the +D3 side while moving from the +D1 side to the −D1 side as proceeding from the −D2 side to the +D2 side. The long side of the side surface 413d moves from the +D3 side to the −D3 side while moving from the +D1 side to the −D1 side as proceeding from the −D2 side to the +D2 side. The short side of each of the side surfaces 413c and 413d moves from the +D2 side to the −D2 side as proceeding from the +D1 side to the −D1 side. That is, when viewed along the D2 direction, the side surface 413c moves from the −D3 side to the +D3 side while moving from the +D1 side to the −D1 side as proceeding from the −D2 side to the +D2 side. The side surface 413d moves from the +D3 side to the −D3 side while moving from the +D1 side to the −D1 side as proceeding from the −D2 side to the +D2 side.

The plate surface 414p of the plate-shaped member 414 is located on the −D1 side among the two plate surfaces of the plate-shaped member 414. The plate surface 414q of the plate-shaped member 414 is located on the +D1 side among the two plate surfaces of the plate-shaped member 414 and is parallel to the plate surface 414p. The entire region of the plate surface 414p faces the internal space SP2. The plate surfaces 414p and 414q have a trapezoidal shape when viewed from a direction (not shown) orthogonal to each of the plate surfaces.

The sides corresponding to the parallel upper bases of the plate surfaces 414p and 414q of the plate-shaped member 414 are parallel to the D3 direction. The sides corresponding to lower bases parallel to each other of the plate surfaces 414p and 414q of the plate-shaped member 414 are located further towards the +D1 side and the +D2 side than the sides corresponding to the upper bases of the plate surfaces 414p and 414q, and are parallel to the D3 direction. The sides corresponding to a pair of legs of each of the plate surfaces 414p and 414q move from the −D1 side to the +D1 side as proceeding from the −D2 side to the +D2 side. The side corresponding to the leg located on the −D3 side of each of the plate surfaces 414p and 414q moves from the +D3 side to the −D3 side as proceeding from the −D2 side to the +D2 side. The side corresponding to the leg located on the +D3 side of each of the plate surfaces 414p and 414q moves from the −D3 side to the +D3 side as proceeding from the −D2 side to the +D2 side. That is, when viewed along the D1 direction, the plate surfaces 414p and 414q move from the −D1 side to the +D1 side as proceeding from the −D2 side to the +D2 side, and the dimension of each of the plate surfaces 414p and 414q in the D3 direction increases as proceeding from the −D2 side to the +D2 side.

The end surface 414a of the plate-shaped member 414 is located on the −D1 side and the −D2 side of the two end surfaces of the plate-shaped member 414. The end surface 414b of the plate-shaped member 414 is located on the +D1 side and the +D2 side of the two end surfaces of the plate-shaped member 414, and is parallel to the end surface 414a. The end surfaces 414a and 414b have a rectangular shape when viewed from a direction (not shown) orthogonal to each of the plate surfaces. The long sides of each of the end surfaces 414a and 414b are parallel to the D3 direction. A dimension of the long side of the end surface 414a in the D3 direction is equal to a dimension of the incident end 142a of the light guide element 142 in the D3 direction. A dimension of the long side of the end surface 414b in the D3 direction is equal to a dimension of the emission end 142b of the light guide element 142 in the D3 direction. The short side of each of the end surfaces 414a and 414b may move from the +D2 side to the −D2 side as proceeding from the −D1 side to the +D1 side, and is preferably parallel to the D3 direction. That is, the end surfaces 414a and 414b are substantially parallel to a plane including the D1 and D3 directions.

The side surface 414c of the plate-shaped member 414 is located on the +D3 side among the two side surfaces of the plate-shaped member 414. The side surface 414d of the plate-shaped member 414 is located on the −D3 side among the two side surfaces of the plate-shaped member 414. The side surfaces 414c and 414d have a rectangular shape when viewed from a direction (not shown) orthogonal to each of the plate surfaces. The long side of the side surface 414c moves from the −D3 side to the +D3 side while moving from the −D1 side to the +D1 side as proceeding from the −D2 side to the +D2 side. The long side of the side surface 414d moves from the +D3 side to the −D3 side while moving from the −D1 side to the +D1 side as proceeding from the −D2 side to the +D2 side. The short side of each of the side surfaces 414c and 414d moves from the +D2 side to the −D2 side as proceeding from the −D1 side to the +D1 side. That is, when viewed along the D2 direction, the side surface 414c moves from the −D3 side to the +D3 side while moving from the −D1 side to the +D1 side as proceeding from the −D2 side to the +D2 side. The side surface 414d moves from the +D3 side to the −D3 side while moving from the −D1 side to the +D1 side as proceeding from the −D2 side to the +D2 side.

The material of the plate-shaped members 411, 412, 413, and 414 of the light guide element 142 includes, for example, at least one of Al, Ag, and glass, that is, SiO₂.

The light guide element 141 may include two rectangular plate-shaped members, two trapezoidal plate-shaped members, and the reflection film 251. Such a configuration will be described in detail later using the light guide element 142 as an example.

The plate surface 411p of the plate-shaped member 411 and the side surface 413d of the plate-shaped member 413 are bonded to each other by an adhesive (not shown). The adhesive may be interposed between the plate surface 411p and the side surface 413d in the D3 direction, or may be disposed such that the plate surface 411p and the side surface 413d are in contact with each other from the −D1 side and the +D3 side with respect to an outside of a corner formed by the plate surface 411p and the plate surface 413q of the plate-shaped member 413, that is, a corner formed by the plate surface 411p and the plate surface 413 q. The adhesive is, for example, an ultraviolet curable resin or a thermosetting resin.

The plate surface 412p of the plate-shaped member 412 and the side surface 413c of the plate-shaped member 413 are bonded to each other by an adhesive (not shown). The adhesive may be interposed between the plate surface 412p and the side surface 413c in the D3 direction, or may be disposed such that the plate surface 412p and the side surface 413c are in contact with each other from the −D1 side and the −D3 side with respect to an outside of a corner formed by the plate surface 412p and the plate surface 413q, that is, a corner formed by the plate surface 412p and the plate surface 413q.

The plate surface 411p of the plate-shaped member 411 and the side surface 414d of the plate-shaped member 414 are bonded to each other by an adhesive (not shown). The adhesive may be interposed between the plate surface 411p and the side surface 414d in the D3 direction, or may be disposed such that the plate surface 411p and the side surface 414d are in contact with each other from the +D1 side and the +D3 side with respect to an outside of a corner formed by the plate surface 411p and the plate surface 414q of the plate-shaped member 414, that is, a corner formed by the plate surface 411p and the plate surface 414q.

The plate surface 412p of the plate-shaped member 412 and the side surface 414c of the plate-shaped member 414 are bonded to each other by an adhesive (not shown). The adhesive may be interposed between the plate surface 412p and the side surface 414c in the D3 direction, or may be disposed such that the plate surface 412p and the side surface 414c are in contact with each other from the +D1 side and the −D3 side with respect to an outside of a corner formed by the plate surface 412p and the plate surface 414q, that is, a corner formed by the plate surface 412p and the plate surface 414q.

The internal space SP2 of the light guide element 142 is a space surrounded by at least a part including a central region of the plate-shaped member 411, at least a part including a central region of the plate-shaped member 412, and the plate-shaped members 413 and 414. The plate surfaces 413p and 413q of the plate-shaped member 413 and the plate surfaces 414p and 414q of the plate-shaped member 414 intersect the plate surface 411p of the plate-shaped member 411 from the +D3 side and are substantially orthogonal to the plate surface 411p. The plate surfaces 413p and 413q and the plate surfaces 414p and 414q of the plate-shaped member 414 intersect the plate surface 412p of the plate-shaped member 412 from the −D3 side and are substantially orthogonal to the plate surface 412p.

At least a part of the plate-shaped member 411 including the central region described above is a portion that, when viewed from the +D3 side along the D3 direction, is on the +D1 side of the plate surface 413q of the plate-shaped member 413 and an extension line forming a straight line with the plate surface 413q, and on the −D1 side of the plate surface 414q of the plate-shaped member 414 and an extension line forming a straight line with the plate surface 414q, and functions as the light guide portion 421.

The light guide element 142 includes a light guide portion 430 and an extending portion 422. The light guide portion 430 guides the green light LG incident on the internal space SP2 from the incident end 142a and propagating through the internal space SP2 toward the emission end 142b from the −D2 side to the +D2 side along the D2 direction. The light guide portion 430 includes the light guide portions 421 of the plate-shaped members 411 and 412 and the plate-shaped members 413 and 414.

When viewed from the +D3 side along the D3 direction, in the plate-shaped member 411, a portion on the −D1 side of the plate surface 413q of the plate-shaped member 413 and an extension line forming a straight line with the plate surface 413q and a portion on the +D1 side of the plate surface 414q of the plate-shaped member 414 and an extension line forming a straight line with the plate surface 414q function as the extending portion 422. The extending portion 422 is located at a position overlapping the emission end 142b in the D2 direction, which is along an optical axis AX of the green light LG and a central axis CX of the light guide element 142, and extends along a plane intersecting the optical axis AX, specifically, a plane including the D1 and D3 directions, relative to the light guide portion 430. The extending portion 422 of the plate-shaped members 411 and 412 extends along the D1 direction. In FIG. 1, the extending portion 422 of each of the plate-shaped members 411 and 412 of the light guide element 142 is omitted.

As shown in FIG. 2, at least a part of the plate-shaped member 412 including the central region described above is a portion that, when viewed from the −D3 side along the D3 direction, is on the +D1 side of the plate surface 413q of the plate-shaped member 413 and an extension line forming a straight line with the plate surface 413q, and on the −D1 side of the plate surface 414q of the plate-shaped member 414 and an extension line forming a straight line with the plate surface 414q, and functions as the light guide portion 421. When viewed from the −D3 side along the D3 direction, in the plate-shaped member 412, a portion on the −D1 side of the plate surface 413q of the plate-shaped member 413 and an extension line forming a straight line with the plate surface 413q and a portion on the +D1 side of the plate surface 414q of the plate-shaped member 414 and an extension line forming a straight line with the plate surface 414q function as the extending portion 422.

As described above, the internal space SP2 of the light guide element 142 is a space surrounded by the light guide portions 421 of the plate-shaped members 411 and 412 and the plate-shaped members 413 and 414. As the incident end 142a of the light guide element 142, an opening AP1 surrounded by the end surface 411a of the light guide portion 421 of the plate-shaped member 411, the end surface 412a of the light guide portion 421 of the plate-shaped member 412, the end surface 413a of the plate-shaped member 413, and the end surface 414a of the plate-shaped member 414 acts. When viewed from the −D2 side along the D2 direction, a peripheral edge of the opening AP1 and a peripheral edge of the incident end 142a of the light guide element 142 are constituted by the long side on the +D3 side of the end surface 411a of the light guide portion 421 of the plate-shaped member 411, the long side on the −D3 side of the end surface 412a of the light guide portion 421 of the plate-shaped member 412, the long side on the +D1 side of the end surface 413a of the plate-shaped member 413, and the long side on the −D1 side of the end surface 414a of the plate-shaped member 414.

When viewed along the D3 direction, each of the light guide portions 421 of the plate-shaped members 411 and 412 has a trapezoidal shape. The dimension of the side on the −D2 side corresponding to the upper bases of the plate surfaces 411p and 411q of the light guide portion 421 of the plate-shaped members 411 and 412 is set based on design conditions and a relative relationship to be described later according to the sizes of the incident end 142a and the light emitting surface 122e of the light source 122 in the D1 direction. The dimension of the side on the +D2 side corresponding to the lower bases of the plate surfaces 411p and 411q of the light guide portion 421 of the plate-shaped members 411 and 412 is set based on design conditions and a relative relationship to be described later according to the size of the emission end 142b and the modulation surface of the light modulation element 182 in the D1 direction.

In consideration of the size and the like of the light source 122, a width, that is, a dimension WL1 of an end side parallel to the D1 direction on the −D2 side forming the peripheral edge of the opening AP1 on the plate surfaces 411p and 411q of each light guide portion 421 of the plate-shaped members 411 and 412 is 1 mm or more and 3 mm or less, for example, about 2 mm. A width, that is, a dimension WL2 of an end side parallel to the D1 direction on the +D2 side in the plate surfaces 411p and 412p of each light guide portion 421 of the plate-shaped members 411 and 412 is 14 mm or more and 16 mm or less, for example, about 15 mm. A length in the D2 direction, that is, a dimension TL of each of the four plate-shaped members 411, 412, 413, and 414 from the incident end 142a to the emission end 142b is, for example, 5 mm or more and 25 mm or less.

In order to planarize the end surfaces 411a, 412a, 413a, and 414a surrounding the opening AP1, for example, the end surfaces 411a and 412a are cut or polished in parallel to a plane including the D1 and D3 directions at the same position in the D2 direction, and the end surface 413a is cut or polished in parallel to a plane including the D1 and D3 directions at the same position as the end surfaces 411a and 412a in the D2 direction. Since the end surfaces 411a, 412a, 413a, and 414a are flush with one another, a support member (not shown) can be easily attached to the light guide element 142, or the light guide element 142 can be easily accommodated in the support member. Since the end surfaces 411a, 412a, 413a, and 414a are flush with one another, when components such as optical elements in contact with the incident end 142a of the light guide element 142 and the end surfaces 411a, 412a, 413a, and 414a surrounding the incident end 142a from the −D2 side are disposed, the components are easily disposed, and the components are stabilized.

As the emission end 142b of the light guide element 142, an opening AP2 surrounded by the end surface 411b of the light guide portion 421 of the plate-shaped member 411, the end surface 412b of the light guide portion 421 of the plate-shaped member 412, the end surface 413b of the plate-shaped member 413, and the end surface 414b of the plate-shaped member 414 acts. When viewed from the +D2 side along the D2 direction, the peripheral edge of the opening AP2 and the peripheral edge of the emission end 142b of the light guide element 142 are constituted by the long side on the +D3 side of the end surface 411b of the light guide portion 421 of the plate-shaped member 411, the long side on the −D3 side of the end surface 412b of the light guide portion 421 of the plate-shaped member 412, the long side on the +D1 side of the end surface 413b of the plate-shaped member 413, and the long side on the −D1 side of the end surface 414b of the plate-shaped member 414.

In order to planarize the end surfaces 411b, 412b, 413b, and 414b surrounding the opening AP2, for example, the end surfaces 411b and 412b are cut or polished in parallel to a plane including the D1 and D3 directions at the same position in the D2 direction, and the end surface 413b is cut or polished in parallel to a plane including the D1 and D3 directions at the same position as the end surfaces 411b and 412b in the D2 direction. Since the end surfaces 411b, 412b, 413b, and 414b are flush with one another, a support member (not shown) can be easily attached to the light guide element 142, or the light guide element 142 can be easily accommodated in the support member. Since the end surfaces 411b, 412b, 413b, and 414b are flush with one another, when components such as optical elements in contact with the emission end 142b of the light guide element 142 and the end surfaces 411b, 412b, 413b, and 414b surrounding the emission end 142b from the +D2 side are disposed, the components are easily disposed, and the components are stabilized.

The reflection film 252 is provided on the plate surface 411p of the light guide portion 421 of the plate-shaped member 411 facing the internal space SP2, the plate surface 412p of the light guide portion 421 of the plate-shaped member 412, the plate surface 413p of the plate-shaped member 413, and the plate surface 414p of the plate-shaped member 414. The reflection surface 142r of the light guide element 142 is a surface on which the green light LG is reflected in the reflection film 252. The plate surface 411p of the plate-shaped member 411 acts as a reflection surface that reflects the green light LG by stacking the reflection film 252, and corresponds to a third plate surface and a third reflection surface. The plate surface 412p of the plate-shaped member 412 acts as a reflection surface that reflects the green light LG by stacking the reflection film 252, and corresponds to a first plate surface and a first reflection surface. The plate surface 413p of the plate-shaped member 413 acts as a reflection surface that reflects the green light LG by stacking the reflection film 252, and corresponds to a fourth plate surface and a fourth reflection surface. The plate surface 414p of the plate-shaped member 414 acts as a reflection surface that reflects the green light LG by stacking the reflection film 252, and corresponds to a second plate surface and a second reflection surface.

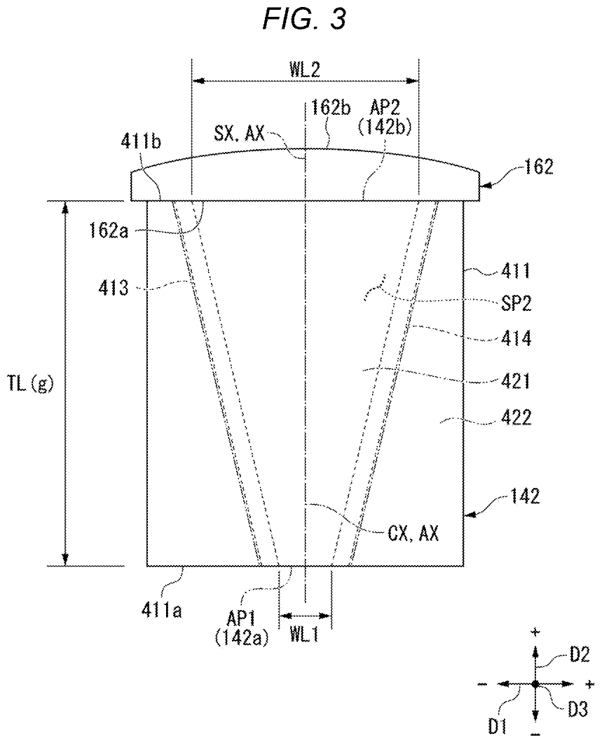

FIG. 3 is a schematic view of the light guide element 142 and the parallelizing element 162 when viewed from the −D3 side along the D3 direction. As shown in FIG. 3, the parallelizing element 162 is a planoconvex lens and has an incident surface 162a and an emission surface 162b. The incident surface 162a is a flat surface parallel to a plane including the D1 and D3 directions. The extending portion 422 of the light guide element 142 extends outward from a peripheral edge of the light guide portion 421 on the +D2 side along a plane including the D1 and D3 directions. The incident surface 162a of the parallelizing element 162 is in contact with each of the end surface 411b of the plate-shaped member 411, the end surface 412b of the plate-shaped member 412, the end surface 413b of the plate-shaped member 413, and the end surface 414b of the plate-shaped member 414 of the light guide element 142 from the +D2 side.

When viewed along the D2 direction, a dimension of the incident surface 162a of the parallelizing element 162 and an opening of the parallelizing element 162 are larger than at least a region occupied by the opening AP2 in a plane including the D1 and D3 directions centered on the central axis SX of the parallelizing element 162 that forms the same straight line as the central axis CX of the light guide element 142, and are larger than, for example, a circumscribed circle of a peripheral edge of a frame-shaped end surface formed by the end surfaces 411b and 412b of the light guide portion 421 of the plate-shaped members 411 and 412, the end surface 413b of the plate-shaped member 413, and the end surface 414b of the plate-shaped member 414. When viewed along the D2 direction, the dimension of the incident surface 162a of the parallelizing element 162 and the opening of the parallelizing element 162 are larger than the circumscribed circle of the region occupied by the end surfaces 411b and 412b including the extending portions 422 of the plate-shaped members 411 and 412, the end surface 413b of the plate-shaped member 413, and the end surface 414b of the plate-shaped member 414.

Since the light guide element 142 has the extending portion 422, when the light guide element 142 and the parallelizing element 162 are aligned by a method of arranging the central axis CX of the light guide element 142 and the central axis SX of the parallelizing element 162 on the same straight line at the time of manufacturing the optical module 310, the incident surface 162a of the parallelizing element 162 is prevented from being scratched or damaged. As a result, it is easy to dispose the parallelizing element 162 on the end surfaces 411b and 412b of the extending portions 422 of the plate-shaped members 411 and 412 of the light guide element 142, and disturbance of the wavefront and an illuminance distribution of the green light LG emitted from the parallelizing element 162 and unexpected scattering and diffusion are reduced.

Since the light guide element 142 has the extending portion 422, an area in which the end surface 411b of the plate-shaped member 411 is in contact with the incident surface 162a of the parallelizing element 162 and an area in which the end surface 412b of the plate-shaped member 412 is in contact with the incident surface 162a of the parallelizing element 162 are enlarged as compared with the case in which the extending portion 422 is not provided, and the parallelizing element 162 disposed in contact with the light guide element 142 from the +D2 side is stabilized.

When viewed from the +D2 side along the D2 direction, a maximum dimension of the extending portion 422 in a plane including the D1 and D3 directions, that is, a dimension of the extending portion 422 extending outward from the peripheral edge of the frame-shaped end surface constituted by the end surfaces 411b and 412b of the light guide portion 421 of the plate-shaped members 411 and 412, the end surface 413b of the plate-shaped member 413, and the end surface 414b of the plate-shaped member 414 is appropriately set according to the size of the incident surface 162a of the parallelizing element 162, and an end farthest from the central axis CX in the radial direction in each of the end surfaces 411b and 412b substantially overlaps the peripheral edge farthest from the central axis SX in the radial direction in the parallelizing element 162.

Although not shown, each of the light guide elements 141 and 143 includes, for example, two plate-shaped members having substantially square plate surfaces similarly to the plate-shaped members 411 and 412 as described above, and two plate-shaped members having trapezoidal plate surfaces similarly to the plate-shaped members 413 and 414 as described above, and is implemented similarly to the light guide element 142.

In at least one light guide element of the light guide elements 141, 142, and 143, the plate-shaped members 411 and 412 or a member corresponding to the plate-shaped members may include only the light guide portion 421 and may not include the extending portion 422.

Next, preferable design conditions and a relative relationship between the light source corresponding to each color light and the light guide element in the optical module 310, and preferable design conditions and a relative relationship between the light guide element, the parallelizing element, and the light modulation element corresponding to each color light will be described with reference to the drawings. In the following description, the green light emitting portion 102 including the light source 122, the light guide element 142, and the parallelizing element 162 corresponding to the green light LG, and the light modulation element 182 are cited as an example, and preferable design conditions and a relative relationship are also applied to the red light emitting portion 101 and the light modulation element 181 corresponding to the red light LR, and the blue light emitting portion 103 and the light modulation element 183 corresponding to the blue light LB.

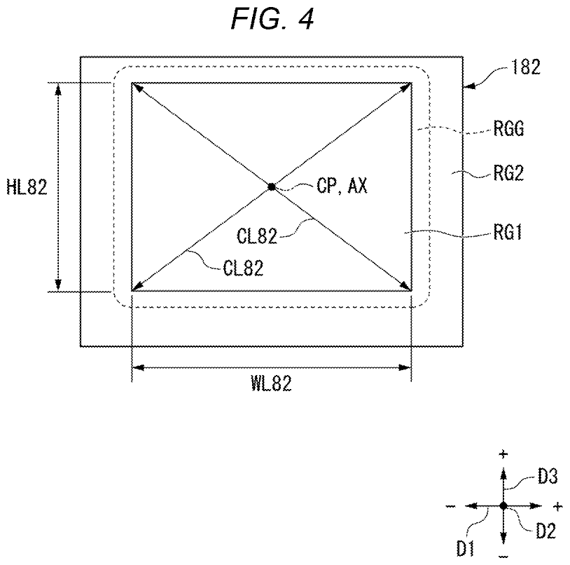

FIG. 4 is a schematic view of the light modulation element 182 and is a front view when viewed from the −D2 side along the D2 direction. As shown in FIG. 4, when viewed from the −D2 side along the D2 direction, the light modulation element 182 is divided into a light receiving region RG1 and a peripheral region RG2. A center CP of the light receiving region RG1 overlaps the optical axis AX of the green light LG incident on the light modulation element 182 from the −D2 side and a center of a beam region of the green light LG incident on the light modulation element 182 from the −D2 side. The peripheral region RG2 surrounds the light receiving region RG1 in a plane including the D1 and D3 directions.

When viewed from the −D2 side along the D2 direction, the light receiving region RG1 of the light modulation element 182 has a rectangular shape having long sides parallel to the D1 direction and short sides parallel to the D3 direction. A size, that is, a dimension of the light receiving region RG1 in the D1 direction is WL82, and a size, that is, a dimension of the light receiving region RG1 in the D3 direction is HL82. An area AR1 of the light receiving region RG1 is represented by WL82×HL82.

A plurality of pixels (not shown) of the light modulation element 182 are disposed in a region on the light receiving region RG1 side in a plane including at least the D1 and D3 directions in the light receiving region RG1 and the peripheral region RG2, and are two-dimensionally arranged along each of the D1 and D3 directions. When viewed from the −D2 side along the D2 direction, an illumination region RGG of the green light LG incident on the light modulation element 182 from the −D2 side overlaps the light receiving region RG1. The green light LG incident on the light receiving region RG1 is modulated according to the image information as described above to generate the image light IG.

When viewed from the −D2 side along the D2 direction, in the optical module 310 according to the present embodiment, the illumination region RGG of the green light LG emitted from the emission end 142b of the light guide element 142 and then received by the light modulation element 182 is at least larger than the light receiving region RG1 and smaller than an outer peripheral edge of the peripheral region RG2. That is, the illumination region RGG overlaps a part of the peripheral region RG2 around the light receiving region RG1. A light-shielding film (not shown) that shields the green light LG is disposed on the −D2 side of at least the plurality of pixels in the peripheral region RG2. The green light LG incident on the peripheral region RG2 does not generate the image light IG. With the above-described arrangement configuration, it is possible to prevent a rapid decrease in the use efficiency of the green light LG in the light receiving region RG1 of the light modulation element 182.

The light receiving region RG1 of the light modulation element 182 acts as a region for receiving the green light LG emitted from the light guide element 142 and passing through the parallelizing element 162 and the light-incident-side polarization element 172, and constitutes the modulation surface of the light modulation element 182. A dimension CL82 of a diagonal line of the light receiving region RG1, that is, a diagonal size is, for example, within a range of 0.5 inches to 1.9 inches. When the dimension CL82 of the diagonal line of the light receiving region RG1 is within the above-described range, the light use efficiency in the light modulation element 182 is improved, and an excessive increase in size of the light modulation element 182 is prevented.

As described above, the area AR2 of the emission end 142b of the light guide element 142 is represented by the product of the dimension WL2, which is a length of an end side parallel to the D1 direction on the +D2 side forming the peripheral edge of the opening AP2 on the plate surfaces 411p and 412p of the light guide portion 421 of each of the plate-shaped members 411 and 412, and the dimension HL2, which is a length of an end side parallel to the D3 direction on the plate surface 413p of the plate-shaped member 413 and the plate surface 414p of the plate-shaped member 414, as described above. In the optical module 310, the area AR1 of the light receiving region RG1 of the light modulation element 182 and the area AR2 of the emission end 142b of the light guide element 142 satisfy the following Equation (1).

$$1.1 \times AR 1 \leq AR 2 \leq 1.9 \times AR 1 \qquad ( 1 )$$

For example, the configuration of each of the green light emitting portion 102 and the light modulation element 182 and the result of numerical calculation based on the relative relationship will be described. In the numerical calculation example, it is assumed that the shape of the emission end 142b of the light guide element 142 corresponds to the shape of the light receiving region RG1 of the light modulation element 182 when viewed along the D2 direction. Specifically, when the dimension WL2 of the emission end 142b of the light guide element 142 is Q times the dimension WL82 of the light receiving region RG1 of the light modulation element 182 in the D1 direction, for example, the dimension HL2 of the emission end 142b of the light guide element 142 in the D3 direction is about (Q −0.2) times to (Q+0.2) times the dimension HL82 of the light receiving region RG1 of the light modulation element 182. In the present numerical calculation example, the design parameters related to the region on which the green light LG is incident and the region from which the green light LG is emitted in each component of the green light emitting portion 102 are appropriately set, and include, for example, suitable numerical values exemplified above or predetermined values within the ranges of numerical values.

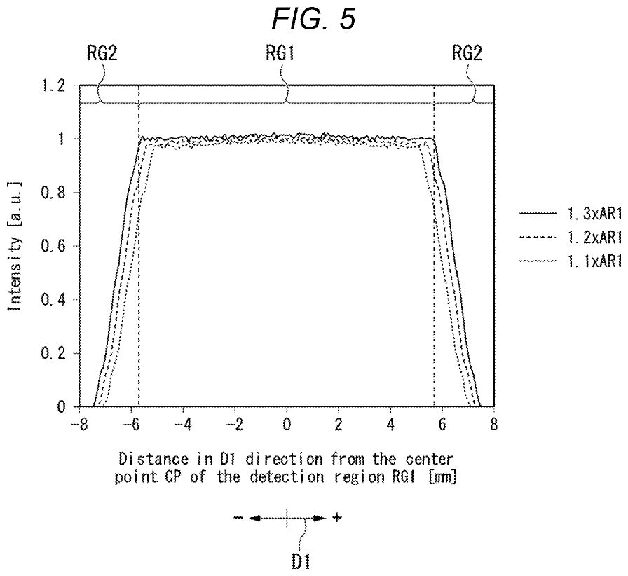

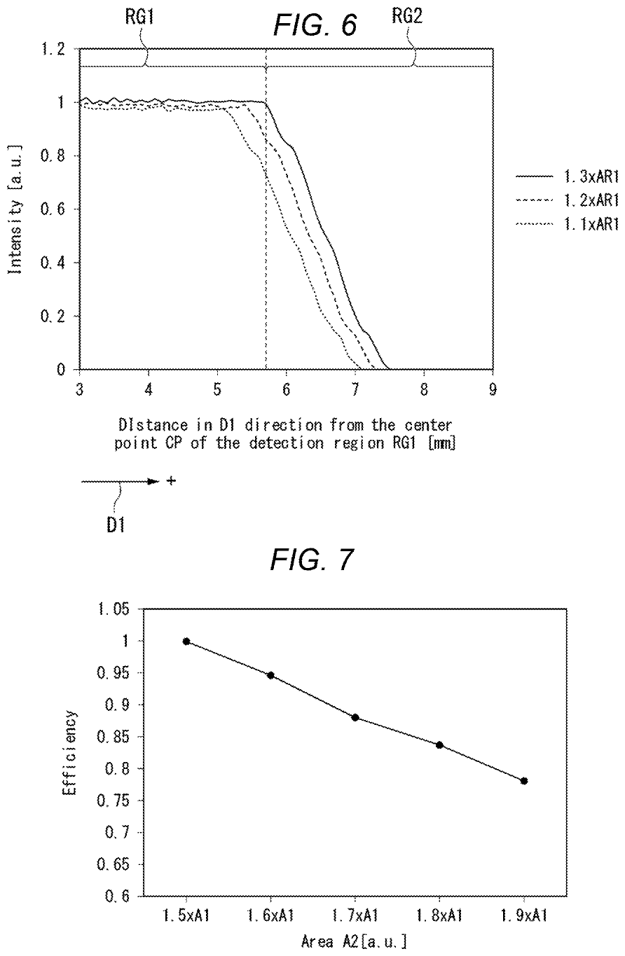

FIG. 5 is a graph showing a change in a light intensity of the green light LG with respect to a distance in the D1 direction from the center CP of the light receiving region RG1 of the light modulation element 182 obtained by the numerical calculation. FIG. 6 is a graph showing a change in the light intensity of the green light LG with respect to the distance in the D1 direction from the center CP of the light receiving region RG1 obtained by the numerical calculation, and is an enlarged view of a range in which the distance in the D1 direction from the center CP of the light receiving region RG1 is 3 mm to 9 mm in FIG. 5. Horizontal axes of the graphs of FIGS. 5 and 6 represent the distance in the D1 direction from the center CP of the light receiving region RG1. Vertical axes of the graphs of FIGS. 5 and 6 represents a relative light intensity of the green light LG incident on the light modulation element 182.

As shown in FIGS. 5 and 6, when the area AR2 of the emission end 142b of the light guide element 142 is 1.1 times the area AR1 of the light receiving region RG1 of the light modulation element 182, that is, when the area AR2 is AR2=1.1×AR1, when the area AR2 is AR2=1.2×AR1, and when the area AR2 is AR2=1.3×AR1, the relative light intensity of the green light LG emitted to the light receiving region RG1 is a value close to 1.0 which is a maximum value in a range from the predetermined distance on the −D1 side to a predetermined distance on the +D1 side with respect to the center CP of the light receiving region RG1, decreases substantially linearly as the relative light intensity proceeds further to the −D1 side than the predetermined distance on the −D1 side to reach 0, and decreases substantially linearly as the relative light intensity proceeds further to the +D1 side than the predetermined distance on the +D1 side to reach 0.

As described above, since the illumination region RGG is at least larger than the light receiving region RG1 and smaller than the outer peripheral edge of the peripheral region RG2, the distance from the center CP to the light intensity of the green light LG reaching 0 in the D1 direction is further on the −D1 side than the −D1 side of the light receiving region RG1 and further on the +D1 side than the +D1 side of the light receiving region RG1. The distance from the center CP to the light intensity of the green light LG reaching 0 in the D1 direction increases symmetrically on the −D1 side and the +D1 side in the D1 direction with respect to a position 0 mm at the center CP as the area AR2 increases to 1.1×AR1, 1.2×AR1, and 1.3×AR1.

The range of the distance in the D1 direction in which the relative light intensity of the green light LG is close to 1.0 and is stable is equivalent to the range of the light receiving region RG1 when AR2=1.3×AR1, and becomes shorter symmetrically on the −D1 side and the +D1 side in the D1 direction with respect to the position 0 mm at the center CP as the area AR2 becomes smaller as 1.2×AR1, 1.1×AR1, and becomes shorter than the range of the light receiving region RG1.

Although FIGS. 5 and 6 show the change in the light intensity of the green light LG with respect to the distance from the center CP of the light receiving region RG1 in the D1 direction, the change and the tendency of the light intensity of the green light LG also appear in the D3 direction, similarly to the change and the tendency of the light intensity of the green light LG in the D1 direction as described above.

The use efficiency of the green light LG in the optical module 310, that is, the light use efficiency, is higher as the range of the distance in the D1 and D3 directions in which the relative light intensity of the green light LG is close to 1.0 is included in the range of the light receiving region RG1, and reaches about 100% of the maximum value when the entire range of the distance in the D1 and D3 directions in which the relative light intensity of the green light LG is close to 1.0 and is stable is included in the range of the light receiving region RG1.

That is, as the area AR2 of the emission end 142b of the light guide element 142 decreases to 1.3×AR1, 1.2×AR1, and 1.1×AR1, the use efficiency of the green light LG reliably reaches the maximum value. On the other hand, as the area AR2 decreases from the state of AR2=1.3×AR1 in which the relative light intensity of the green light LG is close to 1.0 and the range of the distance in the D1 and D3 directions is equivalent to the range of the light receiving region RG1 to 1.2×AR1 and 1.1×AR1, the range of the distance in which the relative light intensity of the green light LG decreases from 1.0 and is less than 1.0 becomes longer in the range of the light receiving region RG1 in the D1 and D3 directions. As a result, when viewed from the −D2 side along the D2 direction, the light intensity of the green light LG received in the region on the outer peripheral side of the light receiving region RG1 is lower than the light intensity of the green light LG in the central region of the light receiving region RG1, the light intensity of the region on the outer peripheral side of the image light IG emitted from the light receiving region RG1 is lower than that in the central region, and the illuminance unevenness of the image light IG emitted from the light modulation element 182 and the optical module 310 increases. When the illuminance unevenness of the image light IG emitted from the light modulation element 182 and the optical module 310 increases, the display quality in the optical module 310 decreases.

As shown in FIGS. 5 and 6, in the case of AR2=1.1×AR1, the relative light intensity of the green light LG at the position of the outer peripheral edge of the light receiving region RG1 in the D1 direction is about 0.8 with respect to the maximum value of 1.0. When the area AR2 of the emission end 142b of the light guide element 142 is 1.1 times or more the area AR1 of the light receiving region RG1 of the light modulation element 182, the illuminance unevenness of the image light IG emitted from the light modulation element 182 and the optical module 310 and a decrease in the display quality in the optical module 310 are appropriately reduced.

When a manufacturing error and the like of the components during mass production of the green light emitting portion 102 and the light modulation element 182 are included, it is more preferable that the area AR2 of the emission end 142b of the light guide element 142 is 1.2 times or more the area AR1 of the light receiving region RG1 of the light modulation element 182, thereby further reducing the illuminance unevenness of the image light IG emitted from the light modulation element 182 and the optical module 310 and the decrease in the display quality in the optical module 310.

When the area AR2 of the emission end 142b of the light guide element 142 is less than 1.1 times the area AR1 of the light receiving region RG1 of the light modulation element 182, the light intensity of the green light LG received in the region on the outer peripheral side of the light receiving region RG1 significantly decreases with respect to the light intensity of the green light LG in the central region of the light receiving region RG1, the light intensity of the region on the outer peripheral side of the image light IG emitted from the light receiving region RG1 is significantly lower than that in the central region, the illuminance unevenness of the image light IG emitted from the light modulation element 182 and the optical module 310 is visualized, is easily visually recognized by an observer, and the display quality in the optical module 310 significantly decreases.

FIG. 7 is a graph showing the use efficiency of the green light LG in the light receiving region RG1 with respect to a magnification of the area AR1 representing the area AR2, which is obtained by the numerical calculation, that is, a change in ratio and efficiency at which the image light IG is generated based on the green light LG incident on the light modulation element 182. A horizontal axis of the graph of FIG. 7 represents the area AR2 of the emission end 142b of the light guide element 142. A vertical axis of the graph of FIG. 7 represents the use efficiency of the green light LG in the light modulation element 182. The use efficiency of the green light LG is represented as a relative value, where the value is set to 1.0 when the area AR2 is 1.5 times the area AR1.

As described above, when the area AR2 of the emission end 142b of the light guide element 142 is larger than 1.3×AR1, in the D1 and D3 directions, the relative light intensity of the green light LG is already close to the maximum value of 1.0 in the entire light receiving region RG1, whereas a light amount of the green light LG having the light intensity of about 1.0 incident on the peripheral region RG2 in which the image light IG is not generated increases, and the loss of the green light LG increases. As shown in FIG. 7, as the area AR2 of the emission end 142b of the light guide element 142 increases to 1.5×AR1, 1.6×AR1, 1.7×AR1, 1.8×AR1, and 1.9×AR1, the light use efficiency in the light modulation element 182 linearly decreases.

As shown in FIG. 7, in the case of AR2=1.9×AR1, relative light use efficiency in the light modulation element 182 is about 0.78. When the area AR2 of the emission end 142b of the light guide element 142 is 1.9 times or less the area AR1 of the light receiving region RG1 of the light modulation element 182, the light use efficiency in the light modulation element 182 is 0.75 or more, the decrease in the light use efficiency in the light modulation element 182 and the optical module 310 is appropriately reduced, and the illuminance and the light amount of the image light IG emitted from the light receiving region RG1 of the light modulation element 182 are appropriately obtained.

When the manufacturing error and the like of the components during mass production of the green light emitting portion 102 and the light modulation element 182 are included, it is more preferable that the area AR2 of the emission end 142b of the light guide element 142 is 1.8 times or less the area AR1 of the light receiving region RG1 of the light modulation element 182, the light use efficiency in the light modulation element 182 reaches 0.8 or more, thereby further reducing the decrease in the light use efficiency in the light modulation element 182 and the optical module 310.

When the area AR2 of the emission end 142b of the light guide element 142 is larger than 1.9 times the area AR1 of the light receiving region RG1 of the light modulation element 182, there is a high possibility that the light use efficiency in the light modulation element 182 is less than 0.75, the decrease in the light use efficiency in the light modulation element 182 and the optical module 310 is not reduced, and the illuminance and the light amount of the image light IG emitted from the light receiving region RG1 of the light modulation element 182 may be insufficient.

In the optical module 310, as described above, the green light LG emitted from the light source 122 is once incident on the light guide element 142 from the incident end 142a, propagates to the +D2 side in the internal space SP2 of the light guide element 142, is emitted from the emission end 142b, passes through the parallelizing element 162, is emitted from the parallelizing element 162 to the +D2 side, and is incident on the light modulation element 182. The light receiving region RG1 of the light modulation element 182 corresponds to a receiving region of the green light LG and corresponds to an emission region of the image light IG.

In the optical module 310, the light source 122 and the pickup element 402 collectively act on the light modulation element 182 as one pseudo light source. The pickup element 402 includes the light guide element 142. The incident end 142a of the light guide element 142 acts on the light modulation element 182 as a light emitting surface or a light emitting region of the pseudo light source of the green light LG. The incident end 142a corresponds to an emission region of the green light LG incident on the light guide element 142. The emission end 142b of the light guide element 142 acts on the light modulation element 182 as an emission surface or an emission region of the green light LG emitted from the pseudo light source. In the present embodiment, since the parallelizing element 162 is in contact with the emission end 142b of the light guide element 142 from the +D2 side, the emission surface 162b of the parallelizing element 162 acts as an emission surface or an emission region of the green light LG emitted from the pseudo light source.

Regarding the area AR3 of the incident end 142a of the light guide element 142, an angle θ1 with respect to the optical axis AX or the central axes CX and SX of the green light LG emitted from the parallelizing element 162, the etendue ET1 in the light receiving region RG1 of the light modulation element 182, and the etendue ET2 in the emission surface 162b of the parallelizing element 162 in contact with the light guide element 142 on the −D2 side, the following Equation (2) is satisfied.

$$ET 2 = π \times AR 3 \times {sin}^{2} θ1 \leq ET 1 \qquad ( 2 )$$

The etendue ET1 in the light receiving region RG1 of the light modulation element 182 depends on the area AR1 of the light receiving region RG1 and an angle of the image light IG emitted from the light receiving region RG1 with respect to the optical axis AX. As shown in Equation (2), the etendue ET2 on the emission surface 162b of the parallelizing element 162 depends on, for example, the area AR3 of the incident end 142a and the angle θ1 with respect to the optical axis AX of the green light LG emitted from the emission surface 162b of the parallelizing element 162.

The etendue ET2 represents the etendue in the emission region of the green light LG incident on the light guide element 142 and the etendue in the emission region of the pseudo light source including the light source 122 and the pickup element 402. As in the present embodiment, in a state in which the parallelizing element 162 is disposed between the light guide element 142 and the light modulation element 182 on the optical path of the green light LG and the incident surface 162a of the parallelizing element 162 is in contact with the emission end 142b of the light guide element 142, or in a state that can be regarded as the above-described state, the etendue ET2 corresponds to the etendue on the emission surface 162b of the parallelizing element 162 as described above.

The angle θ1 represents the spread angle of the green light LG emitted from the emission region of the green light LG incident on the light guide element 142 and the spread angle of the green light LG in the emission region of the pseudo light source including the light source 122 and the pickup element 402. The angle θ1 is an angle formed by the green light LG emitted from the pickup element 402 with respect to the optical axis AX and the central axes CX and SX. As in the present embodiment, in a state in which the parallelizing element 162 is disposed between the light guide element 142 and the light modulation element 182 on the optical path of the green light LG and the incident surface 162a of the parallelizing element 162 is in contact with the emission end 142b of the light guide element 142, or in a state that can be regarded as the above-described state, the angle θ1 corresponds to the spread angle of the green light LG emitted from the emission surface 162b of the parallelizing element 162 toward the light modulation element 182 as described above.

In the optical module 310 according to the present embodiment, the loss of the green light LG emitted from the light source 122 and incident on the light modulation element 182 through the light guide element 142 and the parallelizing element 162 as described above is reliably reduced by satisfying Equation (2).

In the optical module 310 according to the present embodiment, a peak wavelength of the green light LG is taken into consideration, and parameters such as the shape and the dimension of each of the light source 122, the light guide element 142, the parallelizing element 162, and the light modulation element 182, and the distance between the components in the D2 direction are set such that Equations (1) and (2) described above are satisfied. As a result, in the optical module 310 according to the present embodiment, the decrease in the light intensity of the green light LG received in the region on the outer peripheral side of the light receiving region RG1 of the light modulation element 182 with respect to the central region is reduced, the illuminance unevenness of the image light IG emitted from the light modulation element 182 and the decrease in the display quality in the optical module 310 are appropriately reduced, the amount of the green light LG emitted and lost in the peripheral region RG2 of the light modulation element 182 is reduced, the use efficiency of the green light LG received in the light receiving region RG1 is improved, and the loss of the green light LG incident on the light modulation element 182 is favorably reduced.

The above-described parameters related to the green light emitting portion 102 and the light modulation element 182 of the optical module 310 in the present embodiment include, for example, the dimensions of the light emitting surface 122e of the light source 122 in the D1 and D3 directions, orientation characteristics of the green light LG emitted from the light emitting surface 122e, the dimension TL of the light guide element 142 in the D2 direction, the dimension WL1 of the incident end 142a of the light guide element 142 in the D1 direction, the dimension HL1 of the incident end 142a in the D3 direction, the dimension WL2 of the emission end 142b of the light guide element 142 in the D1 direction, the dimension HL2 of the emission end 142b in the D3 direction, the distance between the light emitting surface 122e and the incident end 142a on the optical axis AX, the diameter and the focal length f of the parallelizing element 162, the dimension WL82 of the light receiving region RG1 of the light modulation element 182 in the D1 direction, the dimension HL82 of the light receiving region RG1 in the D3 direction, the distance between the emission surface 162b of the parallelizing element 162 on the optical axis AX and the incident surface of the light modulation element 182 including the light receiving region RG1, and the like.

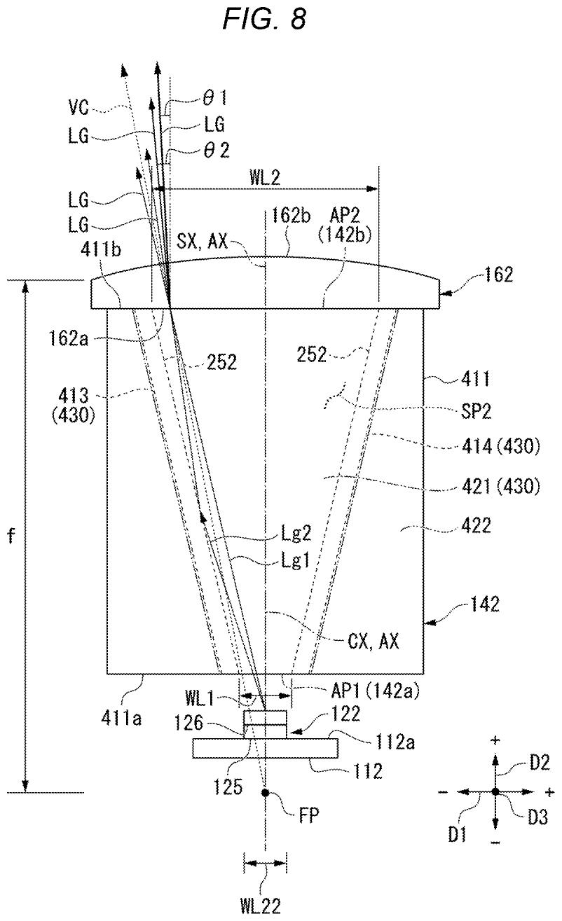

FIG. 8 is a schematic view of the light source 122, the light guide element 142, and the parallelizing element 162. As shown in FIG. 8, the light source 122 includes, for example, the LED main body 125 and the phosphor 126 as described above. The LED main body 125 emits blue light from the emission surface. The phosphor 126 is stacked on the emission surface on the +D2 side of the LED main body 125. The phosphor 126 is excited by the blue light emitted from the LED main body 125 as excitation light, and emits the green light LG from the emission surface on the +D2 side. The light emitting surface 122e of the light source 122 is a surface of the phosphor 126 that is not in contact with the LED main body 125 or a surface that does not face the LED main body 125, and includes an exposed surface on the +D2 side, a side surface substantially parallel to a plane including the D1 and D2 directions, and a side surface substantially parallel to a plane including the D2 and D3 directions.

As described above, the incident surface 162a of the parallelizing element 162 is in contact with the emission end 142b of the light guide element 142. A focal point FP of a planoconvex lens constituting the parallelizing element 162 is at least on the −D2 side of the parallelizing element 162, is further on the −D2 side of the light guide element 142, and is, for example, on the −D2 side of the light source 122 and the substrate 112.

As described above, a certain light beam Lg1 of a part of the green light LG incident on the light guide element 142 directly propagates from the incident end 142a to the emission end 142b without being incident on the reflection surface 142r even once. A certain light beam Lg2 of the remaining part of the green light LG incident on the light guide element 142 is incident on the reflection surface 142r once from the incident end 142a, is reflected by the reflection surface 142r, and then reaches the emission end 142b. When a combined vector VC of the light beams Lg1 and Lg2 emitted from the emission end 142b to the +D2 side is extended to the −D2 side as indicated by a broken line while ignoring the action of the parallelizing element 162, the focal point FP is present in the vicinity of a position intersecting the central axis SX of the parallelizing element 162, the central axis CX of the light guide element 142, and the optical axis AX.

Many paths of the light beams of the green light LG propagating through the internal space SP2 of the light guide element 142 are generated in addition to the paths of the light beams Lg1 and Lg2. When the combined vector VC is extended to the −D2 side on an assumption that the action of the parallelizing element 162 is ignored, the positions intersecting the central axes SX and CX and the optical axis AX do not strictly fall within one point, and are scattered in a region having a slight width in the D2 direction including the focal point FP caused by the combined vector VC. As a result, the focal point FP of the planoconvex lens of the parallelizing element 162 slightly spreads in the D2 direction, but macroscopically forms one point.

A traveling direction of the green light LG emitted from the parallelizing element 162 to the +D2 side forms an angle θ2 larger than 0° with respect to the D2 direction, that is, the central axes SX and CX and the optical axis AX due to the combined vector VC as described above, and is separated from the central axes SX and CX and the optical axis AX as the green light LG moves from the −D2 side to the +D2 side if the parallelizing element 162 is not disposed. The angle θ2 corresponds to a maximum spread angle of the green light LG emitted from the emission end 142b of the light guide element 142 to the +D2 side, and is larger than the angle θ1.

In the optical module 310 according to the present embodiment, Equations (1) and (2) are established, and further, the following Equation (3) is established for the focal length f of the parallelizing element 162 and a length g in the direction along the optical axis AX in the light guide element 142. The length g of the light guide element 142 is equal to the dimension TL of the light guide element 142 as described above.

$$1.1 \times g \leq f \leq 2. \times g \qquad ( 3 )$$

By satisfying Equation (3), the use efficiency of the green light LG incident on the light guide element 142 is improved, and an increase in size of the light guide element 142 in the D2 direction is prevented.

Further, a refractive index of the parallelizing element 162 is preferably 1.8 or more. The refractive index of the parallelizing element 162 is, for example, about 2.0. When the refractive index of the parallelizing element 162 is 1.8 or more, the use efficiency of the green light LG incident on the light guide element 142 is further improved. When the refractive index of the parallelizing element 162 is 1.8 or more, a thickness of the parallelizing element 162 in the D2 direction is reduced with respect to the predetermined focal length f, and an increase in size of the pseudo light source of the green light LG including the parallelizing element 162 and the light guide element 142 in the D2 direction is prevented.

In the optical module 310 according to the present embodiment, Equations (1) and (2) are established, and Equation (4) below is established for the area AR3 of the incident end 142a of the light guide element 142 and the area AR4 of the light emitting surface 122e of the light source 122.

$$1. 0 \times AR 4 \leq AR 3 \leq 4. \times AR 4 \qquad ( 4 )$$

By satisfying Equation (4), the use efficiency of the green light LG incident on the light guide element 142 is improved, and an increase in size of the light guide element 142 in the D2 direction is prevented.

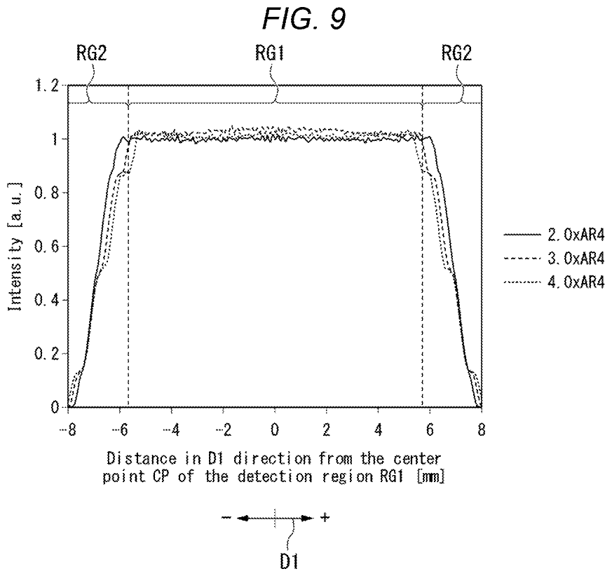

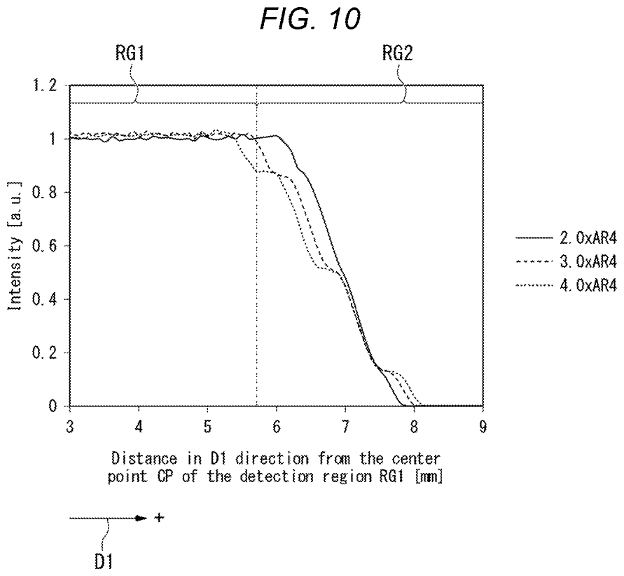

FIG. 9 is a graph showing a change in the light intensity of the green light LG with respect to the distance in the D1 direction from the center CP of the light receiving region RG1 of the light modulation element 182 obtained by the numerical calculation. FIG. 10 is a graph showing a change in the light intensity of the green light LG with respect to the distance in the D1 direction from the center CP of the light receiving region RG1 obtained by the numerical calculation, and is an enlarged view of a range in which the distance in the D1 direction from the center CP of the light receiving region RG1 is 3 mm to 9 mm in FIG. 9. Horizontal axes of the graphs of FIGS. 9 and 10 represent the distance in the D1 direction from the center CP of the light receiving region RG1. Vertical axes of the graphs of FIGS. 9 and 10 represents a relative light intensity of the green light LG incident on the light modulation element 182.

In the numerical calculation example, it is assumed that the shape of the incident end 142a of the light guide element 142 corresponds to the shape of the light emitting surface 122e of the light source 122 when viewed along the D2 direction. Specifically, when the dimension WL1 of the incident end 142a of the light guide element 142 in the D1 direction is Q times a dimension WL22 of the light emitting surface 122e of the light source 122, for example, the dimension of the incident end 142a of the light guide element 142 in the D3 direction is about (Q−0.2) times to (Q+0.2) times the dimension of the light emitting surface 122e of the light source 122.

As shown in FIGS. 9 and 10, when the area AR3 of the incident end 142a of the light guide element 142 is 2.0 times the area AR4 of the light emitting surface 122e of the light source 122, that is, when the area AR3 of the incident end 142a of the light guide element 142 is AR3=2.0×AR4, when the area AR3 of the incident end 142a of the light guide element 142 is AR3=3.0×AR4, and when the area AR3 of the incident end 142a of the light guide element 142 is AR3=4.0×AR4, the relative light intensity of the green light LG emitted to the light receiving region RG1 is a value close to 1.0, which is a maximum value in a range from a predetermined distance on the −D1 side to a predetermined distance on the +D1 side with respect to the center CP of the light receiving region RG1, slightly decreases in a stepwise manner as the relative light intensity proceeds further to the −D1 side than the predetermined distance on the −D1 side to reach 0, and slightly decreases in a stepwise manner as the relative light intensity proceeds further to the +D1 side than the predetermined distance on the +D1 side to reach 0.

The opening AP1 acting as the incident end 142a of the light guide element 142 is larger than the light emitting surface 122e of the light source 122. The distance from the center CP to the light intensity of the green light LG reaching 0 in the D1 direction increases symmetrically on the −D1 side and the +D1 side in the D1 direction with respect to the position 0 mm at the center CP as the area AR3 increases to 2.0×AR4, 3.0×AR4, and 4.0×AR4.

The range of the distance in the D1 direction in which the relative light intensity of the green light LG is close to 1.0 is slightly wider than the range of the light receiving region RG1 when AR3=2.0×AR4, and becomes shorter symmetrically on the −D1 side and the +D1 side in the D1 direction with respect to the position 0 mm at the center CP as the area AR3 becomes larger as 3.0×AR4, 4.0×AR4, and becomes shorter than the range of the light receiving region RG1. That is, as the area AR3 increases, the entire green light LG spreads across the incident surface of the light modulation element 182 including the light receiving region RG1, and a ratio of the region on the outer peripheral side where the relative light intensity is less than 1.0 in the illumination region of the green light LG increases.

Although FIGS. 9 and 10 show the change in the light intensity of the green light LG with respect to the distance from the center CP of the light receiving region RG1 in the D1 direction, the change and the tendency of the light intensity of the green light LG also appear in the D3 direction, similarly to the change and the tendency of the light intensity of the green light LG in the D1 direction as described above.

That is, as the area AR3 of the incident end 142a of the light guide element 142 increases to 2.0×AR4, 3.0×AR4, 4.0×AR4, the use efficiency of the green light LG reliably reaches the maximum value. On the other hand, as the area AR3 increases from the state of AR3=2.0×AR4 in which the relative light intensity of the green light LG is close to 1.0 and the range of the distance in the D1 and D3 directions is equivalent to the range of the light receiving region RG1 to 3.0×AR4 and 4.0×AR4, the range of the distance in which the relative light intensity of the green light LG decreases from 1.0 and is less than 1.0 becomes longer in the range of the light receiving region RG1 in the D1 and D3 directions. As a result, when viewed from the −D2 side along the D2 direction, the light intensity of the green light LG received in the region on the outer peripheral side of the light receiving region RG1 is lower than the light intensity of the green light LG in the central region of the light receiving region RG1, the light intensity of the region on the outer peripheral side of the image light IG emitted from the light receiving region RG1 is lower than that in the central region, and the illuminance unevenness of the image light IG emitted from the light modulation element 182 and the optical module 310 increases. When the illuminance unevenness of the image light IG emitted from the light modulation element 182 and the optical module 310 increases, the display quality in the optical module 310 decreases.

As shown in FIGS. 9 and 10, in the case of AR3=4.0×AR4, the relative light intensity of the green light LG at the position of the outer peripheral edge of the light receiving region RG1 in the D1 direction is about 0.9 with respect to the maximum value of 1.0. When the area AR3 of the incident end 142a of the light guide element 142 is 4.0 times or less the area AR4 of the light emitting surface 122e of the light source 122, the illuminance unevenness of the image light IG emitted from the light modulation element 182 and the optical module 310 and a decrease in the display quality in the optical module 310 are appropriately reduced.

When a manufacturing error and the like of the components during mass production of the green light emitting portion 102 and the light modulation element 182 are included, it is more preferable that the area AR3 of the incident end 142a of the light guide element 142 is 3.6 times or less the area AR4 of the light emitting surface 122e of the light source 122, thereby further reducing the illuminance unevenness of the image light IG emitted from the light modulation element 182 and the optical module 310 and the decrease in the display quality in the optical module 310.

When the area AR3 of the incident end 142a of the light guide element 142 is larger than 4.0 times the area AR4 of the light emitting surface 122e of the light source 122, the light intensity of the green light LG received in the region on the outer peripheral side of the light receiving region RG1 of the light modulation element 182 significantly decreases with respect to the light intensity of the green light LG in the central region of the light receiving region RG1, the light intensity of the region on the outer peripheral side of the image light IG emitted from the light receiving region RG1 is significantly lower than that in the central region, the illuminance unevenness of the image light IG emitted from the light modulation element 182 and the optical module 310 is visualized, is easily visually recognized by an observer, and the display quality in the optical module 310 significantly decreases.

Although not shown, according to the numerical calculation performed by the present disclosers, the relative light use efficiency in the light modulation element 182 is optimally obtained when AR3=1.0×AR4, which is the most preferable condition. As the area AR3 of the incident end 142a of the light guide element 142 becomes larger than 1.0 times the area AR4 of the light emitting surface 122e of the light source 122, the relative light use efficiency in the light modulation element 182 decreases. When the area AR3 of the incident end 142a of the light guide element 142 is larger than 4.0 times the area AR4 of the light emitting surface 122e of the light source 122, the relative light use efficiency in the light modulation element 182 excessively decreases, and the illuminance, the light amount, and the luminance of the image light IG emitted from the light modulation element 182 may be insufficient. When the area AR3 of the incident end 142a of the light guide element 142 is 1.0 times or more the area AR4 of the light emitting surface 122e of the light source 122, the green light LG emitted from the light source 122 is favorably introduced into the light guide element 142, a decrease in light use efficiency in the light modulation element 182 and the optical module 310 is appropriately reduced, and the illuminance and the light amount of the image light IG emitted from the light receiving region RG1 of the light modulation element 182 are appropriately obtained.

When a manufacturing error and the like of the components during mass production of the green light emitting portion 102 and the light modulation element 182 are included, it is more preferable that the area AR3 of the incident end 142a of the light guide element 142 is 2.0 times or more the area AR4 of the light emitting surface 122e of the light source 122, thereby further reducing the decrease in the light use efficiency in the light modulation element 182 and the optical module 310.

When the area AR3 of the incident end 142a of the light guide element 142 changes, a degree of superimposition of the green light LG received in the light receiving region RG1 of the light modulation element 182 changes. As represented by Equation (4), by appropriately setting the area AR3 of the incident end 142a of the light guide element 142, the use efficiency of the green light LG in the pseudo light source including the light source 122 and the light guide element 142 is improved, and an increase in size of the entire light guide element 142 and the pseudo light source is prevented.

When the area AR3 of the incident end 142a of the light guide element 142 is smaller than 1.0 times the area AR4 of the light emitting surface 122e of the light source 122, the light amount of the green light LG emitted from the light source 122 and lost without being introduced into the light guide element 142 increases, and as a result, a decrease in the light use efficiency in the light modulation element 182 and the optical module 310 is not reduced, and there is a concern that the illuminance and the light amount of the image light IG emitted from the light receiving region RG1 of the light modulation element 182 may be insufficient.

### First Modification

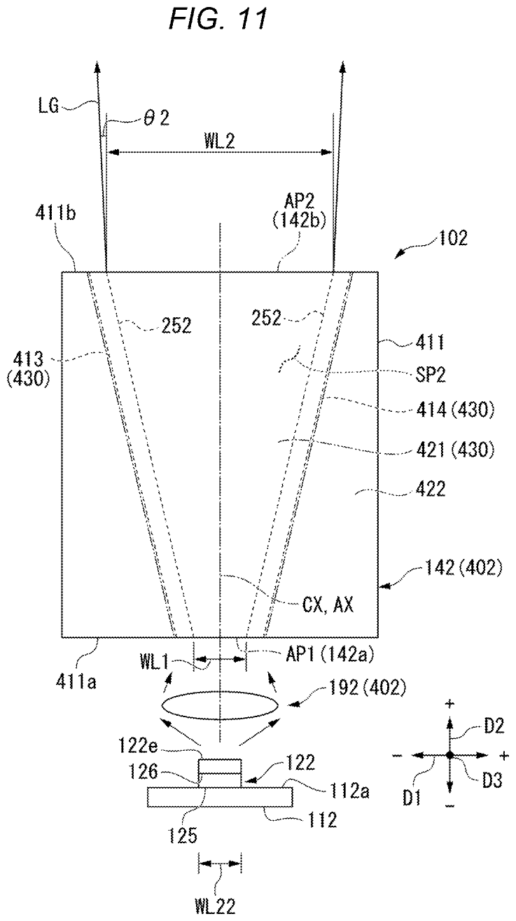

A first modification of the present embodiment will next be described. FIG. 11 is a schematic view of a green light emitting portion 102 according to the first modification of the present embodiment. As shown in FIG. 11, the pickup element 402 of the green light emitting portion 102 may include a converging element 192 and the light guide element 142.

The converging element 192 is provided on the optical path of the green light LG emitted from the light emitting surface 122e of the light source 122, and is disposed on the +D2 side of the light source 122 and at a position overlapping the light source 122 in the D1 and D3 directions. The converging element 192 emits the green light LG emitted from the light emitting surface 122e of the light source 122 and incident from the −D2 side to the +D2 side to reduce the spread angle of the green light LG emitted from the light source 122. The spread angle of the green light LG emitted from the converging element 192 with respect to the optical axis is, for example, within a range of 10° to 45° as an angle formed by the optical axis parallel to the D2 direction and the light beam of the green light LG which spreads most, and is smaller than the spread angle of the green light LG emitted from the light source 122 toward the light guide element 142.

The converging element 192 is, for example, a planoconvex lens or a biconvex lens, and may be an optical element capable of adjusting the spread angle of the green light LG emitted from the light source 122 to a desired spread angle for causing the green light LG to be incident on the light guide element 142 from the −D2 side.

The light guide element 142 takes the green light LG emitted from the converging element 192 into the internal space SP2 from the incident end 142a, guides the green light LG to the +D2 side, and emits the green light LG from the emission end 142b, thereby reducing at least the spread angle of the green light LG emitted from the light source 122. The angle θ2 formed with respect to the optical axis AX of the green light LG emitted from the emission end 142b of the light guide element 142 corresponds to the spread angle of the green light LG emitted from the pickup element 402 in the first modification, and corresponds to the angle θ1 of Equation (2) as described above.

In the pickup element 402 in the first modification of the present embodiment, since the emission region of the green light LG incident on the light guide element 142 corresponds to the emission end 142b, the etendue ET2 of the above-described Equation (2) corresponds to the etendue ET2 at the emission end 142b of the light guide element 142.

In the first modification of the present embodiment, the pickup element 402 includes the converging element 192 instead of the parallelizing element 162, but since the parameters related to the green light emitting portion 102 and the light modulation element 182 of the optical module 310 are set to satisfy the applicable preferable conditions including the relationship of Equations (1), (2), and (4) as in the present embodiment described above, the effects same as those of the present embodiment described above can be obtained.

### Second Modification

A second modification of the present embodiment will next be described. Although not shown, the pickup element 402 of the green light emitting portion 102 may include only the light guide element 142.

In the configuration of the second modification, the light guide element 142 directly takes the green light LG emitted from the light source 122 into the internal space SP2 from the incident end 142a, guides the green light LG to the +D2 side, and emits the green light LG from the emission end 142b, thereby reducing at least the spread angle of the green light LG emitted from the light source 122. The angle θ2 formed with respect to the optical axis AX of the green light LG emitted from the emission end 142b of the light guide element 142 corresponds to the spread angle of the green light LG emitted from the pickup element 402 in the second modification, and corresponds to the angle θ1 of Equation (2) as described above.

In the pickup element 402 of the second modification of the present embodiment, similarly to the first modification, the emission region of the green light LG incident on the light guide element 142 corresponds to the emission end 142b, the etendue ET2 of the above-described Equation (2) corresponds to the etendue ET2 at the emission end 142b of the light guide element 142.

In the second modification of the present embodiment, the pickup element 402 includes only the light guide element 142, but since the parameters related to the green light emitting portion 102 and the light modulation element 182 of the optical module 310 are set to satisfy the applicable preferable conditions including the relationship of Equations (1), (2), and (4) as in the present embodiment described above, the effects same as those of the present embodiment described above can be obtained.

The optical module 310 according to the present embodiment as described above includes the light source (first light source) 122, the pickup element (first pickup element) 402, and the light modulation element (first light modulation element) 182. The light source 122 emits the green light (first light) LG in a wavelength band including a green wavelength band (first wavelength band). The pickup element 402 reduces the spread angle of the green light LG emitted from the light source 122. The light modulation element 182 modulates the green light LG emitted from the pickup element 402 based on image information. The light modulation element 182 has the light receiving region RG1 that receives the green light LG emitted from the pickup element 402. The pickup element 402 includes the light guide element (first light guide element) 142. The light guide element 142 has the incident end (first incident end) 142a on which the green light LG emitted from the light source 122 is incident and the emission end (first emission end) 142b from which the green light LG is emitted, and homogenizes the illuminance (in-plane illuminance) in a plane including the D1 and D3 directions of the green light LG. In the optical module 310 according to the present embodiment, when an area of the light receiving region RG1 when viewed along the optical axis AX of the green light LG is defined as AR1, and an area of the emission end 142b of the light guide element 142 is defined as AR2, Equation (1) is satisfied.

$$1.1 \times AR 1 \leq AR 2 \leq 1.9 \times AR 1 \qquad ( 1 )$$

In the optical module 310 according to the present embodiment, when the area of the incident end 142a of the light guide element 142 is defined as AR3, an angle formed by the green light LG emitted from the pickup element 402 to the +D2 side with respect to the optical axis AX, that is, an angle of the green light LG emitted from the parallelizing element 162 is defined as θ1, an etendue in the light receiving region RG1 of the light modulation element 182 is defined as ET1, and an etendue in the emission region of the green light LG incident on the light guide element 142, that is, the emission surface 162b of the parallelizing element 162 is defined as ET2, Equation (2) is satisfied.

$$ET 2 = π \times AR 3 \times {sin}^{2} θ1 \leq ET 1 \qquad ( 2 )$$

In the optical module 310 according to the present embodiment, with respect to the green light emitting portion 102 including the light source 122 and the pickup element 402 and the light modulation element 182, by satisfying Equations (1) and (2), it is possible to appropriately reduce the illuminance unevenness of the image light IG emitted from the light receiving region RG1 of the light modulation element 182 and a decrease in the display quality, improve the use efficiency of the green light LG received in the light receiving region RG1, and favorably reduce the loss of the green light LG incident on the light modulation element 182. According to the optical module 310 in the present embodiment, it is possible to secure the display quality and further improve the light use efficiency in consideration of the manufacturing error of the components during mass production according to the dimensions and specifications of the light source 122, the parameters related to the optical characteristics, the shape, the dimensions, the refractive index, and the like of the optical element constituting the pickup element 402.

In the optical module 310 according to the present embodiment, the pickup element 402 may include the light guide element 142 on which the green light LG emitted from the light source 122 is directly incident and the parallelizing element 162 that parallelizes the green light LG emitted from the light guide element 142. In this case, the green light emitted from the parallelizing element 162 is incident on the light modulation element 182.

According to the optical module 310 in the present embodiment, the spread angle of the green light LG emitted from the light source 122 can be reduced by the light guide element 142, and then the spread angle of the green light LG emitted from the light guide element 142 can be further reduced by the parallelizing element 162.

In the optical module 310 according to the present embodiment, the pickup element 402 may include the converging element 192 on which the green light LG emitted from the light source 122 is directly incident and the light guide element 142 on which the green light LG emitted from the converging element 192 is incident. In this case, the green light emitted from the light guide element 142 is incident on the light modulation element 182.

According to the optical module 310 in the present embodiment, the spread angle of the green light LG emitted from the light source 122 can be reduced by the converging element 192, and then the spread angle of the green light LG emitted from the converging element 192 can be easily adjusted by the light guide element 142.

The optical module 310 according to the present embodiment further includes the light source (second light source) 121, the light source (third light source) 123, the pickup element (second pickup element) 401, the light modulation element (second light modulation element) 181, the light modulation element (third light modulation element) 183, the light combining element 200, and the projection optical system 320. The light source 121 emits the red light (second light) LR in a wavelength band including a red wavelength band (second wavelength band) different from the green wavelength band. The light source 123 emits the blue light (third light) LB in a wavelength band including a blue wavelength band (third wavelength band) different from the green wavelength band and the red wavelength band. The pickup element 401 reduces the spread angle of the red light LR emitted from the light source 121. The light modulation element 181 modulates the red light LR emitted from the pickup element 401 based on image information. The light modulation element 183 modulates the blue light LB emitted from the light source 123 based on image information. The light combining element 200 combines and emits the image light (first light) IG emitted from the light modulation element 182, the image light (second light) IR emitted from the light modulation element 181, and the image light (third light) IB emitted from the light modulation element 183. The projection optical system 320 projects the image light (light) IM emitted from the light combining element 200.

In the optical module 310 according to the present embodiment, the projection optical system 320 projects full-color image light IM that can be formed of the three primary colors of light. The green image light (first light) IG included in the image light IM is generated based on the green light LG. According to the optical module 310 in the present embodiment, it is possible to appropriately reduce at least a decrease in the display quality due to the image light IG, improve the use efficiency of the image light IG, and favorably reduce the loss of the image light IG in the light modulation element 182.

In the optical module 310 according to the present embodiment, the red image light (second light) IR included in the image light IM is generated based on the red light LR, and the blue image light (third light) IB included in the image light IM is generated based on the blue light LB. Equations (1) and (2) may be satisfied for the red light emitting portion 101 and the light modulation element 181 including the light source 121 and the pickup element 401. Equations (1) and (2) may be satisfied for at least the blue light emitting portion 103 including the light source 123 and the light modulation element 183. According to the optical module 310 in the present embodiment, it is possible to appropriately reduce the decrease in the display quality due to the image light IR and IB, improve the use efficiency of the image light IR and IB, and favorably reduce the loss of the image light IR in the light modulation element 181 and the loss of the image light IB in the light modulation element 183.

In the optical module 310 according to the present embodiment, a diagonal size of the light receiving region RG1 of the light modulation element 182 is 0.5 inches or more and 1.9 inches or less.

In the optical module 310 according to the present embodiment, the light receiving region RG1 forms a modulation surface of the green light LG received by the light modulation element 182. According to the optical module 310 in the present embodiment, since the dimension CL82 of the diagonal line of the light receiving region RG1 is within the range of 0.5 inches or more and 1.9 inches or less, it is possible to improve the light use efficiency in the light modulation element 182 and to prevent an excessive increase in size of the light modulation element 182.

In the optical module 310 according to the present embodiment, when a focal length of the parallelizing element 162 is f and the length of the light guide element 142 in the D2 direction along the optical axis AX is g, Equation (3) is satisfied.

1.1×g≤f≤2.0×g (3)

According to the optical module 310 in the present embodiment, it is possible to enhance the use efficiency of the green light LG incident on the light guide element 142 from the incident end 142a and emitted from the emission surface 162b of the parallelizing element 162, and to prevent an excessive increase in size of the light guide element 142.

In the optical module 310 according to the present embodiment, the refractive index of the parallelizing element 162 is 1.8 or more.

According to the optical module 310 of the present embodiment, it is possible to reduce the thickness of the parallelizing element 162 in the D2 direction, that is, the direction along the optical axis AX and the central axis SX with respect to the predetermined focal length f required for the parallelizing element 162, and to reduce the size of a pseudo light source including the light source 122, the light guide element 142, and the parallelizing element 162 in the D2 direction.

In the optical module 310 according to the present embodiment, the light guide element 142 is a hollow member. The light guide element 142 includes the plate-shaped member (first light guide plate) 412, the plate-shaped member (second light guide plate) 414, the plate-shaped member (third light guide plate) 411, and the plate-shaped member (fourth light guide plate) 413. The plate-shaped member 412 has the plate surface (first plate surface) 412p that reflects the green light LG by stacking the reflection films 252. The plate-shaped member 414 is disposed to intersect the plate surface 412p of the plate-shaped member 412, for example, orthogonal to the plate surface 412p, and has the plate surface (second plate surface) 414p on which the reflection film 252 is stacked to reflect the green light LG. The plate-shaped member 411 is disposed to intersect the plate surface 414p of the plate-shaped member 414, for example, orthogonal to the plate surface 414p, and has the plate surface (third plate surface) 411p on which the reflection film 252 is stacked to reflect the green light LG. The plate-shaped member 413 is disposed to intersect the plate surface 412p of the plate-shaped member 412 and the plate surface 411p of the plate-shaped member 411, for example, orthogonally to each of the plate surfaces 411p and 412p, and has the plate surface (fourth plate surface) 413p on which the reflection film 252 is stacked to reflect the green light LG.

In the optical module 310 according to the present embodiment, the green light LG emitted from the light source 122 is incident on the opening AP1 on the −D2 side surrounded by the four plate-shaped members 411, 412, 413, and 414 of the light guide element 142, and the opening AP1 acts as the incident end 142a of the light guide element 142. The green light LG is emitted from the opening AP2 on the +D2 side surrounded by the four plate-shaped members 411, 412, 413, and 414 of the light guide element 142, and the opening AP2 acts as the emission end 142b of the light guide element 142. According to the optical module 310 in the present embodiment, the light guide element 142 can be more easily formed by assembling the four plate-shaped members 411, 412, 413, and 414 as described above than the hollow member integrally molded or implemented.

In the optical module 310 according to the present embodiment, the plate-shaped member 412 has the quadrangular plate surfaces 412p and 412q, and is a quadrangular plate when viewed along a direction orthogonal to the plate surfaces 412p and 412q. The plate-shaped member 414 has the trapezoidal plate surfaces 414p and 414q, and is a trapezoidal plate when viewed along a direction orthogonal to the plate surfaces 414p and 414q. The plate-shaped member 411 has the quadrangular plate surfaces 411p and 411q, and is a quadrangular plate when viewed along a direction orthogonal to the plate surfaces 411p and 411q. The plate-shaped member 413 has the trapezoidal plate surfaces 413p and 413q, is a trapezoidal plate when viewed along a direction orthogonal to the plate surfaces 413p and 413q, and has the same shape as the plate-shaped member 414. In the optical module 310 according to the present embodiment, the opening AP2 acting as the emission end 142b of the light guide element 142 is larger than the opening AP1 acting as the incident end 142a.

In the optical module 310 according to the present embodiment, the lengths of the end sides corresponding to the upper bases of the plate surfaces 413p and 413q of the plate-shaped member 413 and the lengths of the end sides corresponding to the upper bases of the plate surfaces 414p and 414q of the plate-shaped member 414 are equal to the dimensions of one side of the short side and the long side corresponding to each of the above-described end sides at the incident end 142a of the light guide element 142, and are, for example, equal to the dimensions of the short sides. The lengths of the end sides corresponding to the lower bases of the plate surfaces 413p and 413q of the plate-shaped member 413 and the lengths of the end sides corresponding to the lower bases of the plate surfaces 414p and 414q of the plate-shaped member 414 are equal to the dimensions of one side of the short side and the long side corresponding to each of the above-described end sides at the emission end 142b of the light guide element 142, and are, for example, equal to the dimensions of the short sides. An interval between the ends of the plate surfaces 413p and 414p, which are orthogonal to the plate surfaces 411p and 412p respectively, on the −D2 side, is equal to the dimension of the other of the short side and the long side of the incident end 142a. An interval between the ends of the plate surfaces 413p and 414p, which are orthogonal to the plate surfaces 411p and 412p respectively, on the +D2 side, is equal to the dimension of the other of the short side and the long side of the emission end 142b. Therefore, the emission end 142b and the opening AP2 of the light guide element 142 are larger than the incident end 142a and the opening AP1.

In the optical module 310 according to the present embodiment, the light guide element 142 that expands from the incident end 142a toward the emission end 142b along the central axis CX, that is, the D2 direction can be easily assembled by the two quadrangular plate-shaped members 411 and 412 and the two trapezoidal plate-shaped members 413 and 414. According to the optical module 310 in the present embodiment, since two plate-shaped members 411 and 412 of the four plate-shaped members 411, 412, 413, and 414 are quadrangular plate-shaped members, it is possible to reduce the number of times of processing for cutting out the plate-shaped members from a plate-shaped base material and the cost, and to stably hold the plate-shaped members 411 and 412 during assembly. According to the optical module 310 in the present embodiment, by appropriately setting the sizes of the incident end 142a and the opening AP2 and the sizes of the emission end 142b and the opening AP2, the green light LG emitted from the light source 122 and incident on the light guide element 142 from the incident end 142a can be expanded to a desired size according to the size of the emission end 142b.

In the optical module 310 according to the present embodiment, when the area of the incident end 142a of the light guide element 142 is AR3 and the area of the light emitting surface 122e of the light source 122 is AR4, Equation (4) is established.

$$1. 0 \times AR 4 \leq AR 3 \leq 4. \times AR 4 \qquad ( 4 )$$

In the optical module 310 according to the present embodiment, the green light LG emitted from the light source 122 is favorably guided from the incident end 142a to the internal space SP2 of the light guide element 142 by satisfying Equation (4) for the green light emitting portion 102 including the light source 122, the light guide element 142, and the parallelizing element 162 and the light modulation element 182. According to the optical module 310 in the present embodiment, it is possible to appropriately reduce the illuminance unevenness of the image light IG emitted from the light receiving region RG1 of the light modulation element 182 and a decrease in the display quality, improve the use efficiency of the green light LG received in the light receiving region RG1, and favorably reduce the loss of the green light LG incident on the light modulation element 182. According to the optical module 310 in the present embodiment, it is possible to prevent an increase in size of the pseudo light source including the light source 122 and the light guide element 142.

In the optical module 310 according to the present embodiment, the light guide element 142 includes the light guide portion 430 and the extending portion 422. The light guide portion 430 guides the green light LG emitted from the light source 122 from the incident end 142a toward the emission end 142b, and is implemented by, for example, the light guide portion 421 of each of the plate-shaped members 411 and 412 forming the internal space SP2, and the plate-shaped members 413 and 414. The extending portion 422 extends along a plane intersecting the optical axis AX from a peripheral edge on the emission end 142b side, that is, the +D2 side in the D2 direction along the optical axis AX in the light guide portion 430. For example, the extending portion 422 extends from the peripheral edge on the +D2 side of the light guide portion 421 of each of the plate-shaped members 411 and 412 to the −D1 side and the +D1 side along the D1 direction. The extending portion 422 is in contact with the parallelizing element 162 together with the end of the light guide portion 430 on the emission end 142b side.

In the optical module 310 according to the present embodiment, since the parallelizing element 162 is larger than the emission end 142b of the light guide element 142, that is, the opening AP2 in the plane intersecting the optical axis AX of the green light LG, the parallelizing element 162 is supported and stabilized by the extending portion 422 in addition to the end of the light guide portion 421 on the emission end 142b side. In the optical module 310 according to the present embodiment, when the central axis CX of the light guide element 142 and the central axis SX of the parallelizing element 162 are aligned during manufacturing, it is possible to prevent scratching and a decrease in surface accuracy on the end surface along the plane including the D1 and D3 directions on the +D2 side of the light guide element 142 and the incident surface 162a of the parallelizing element 162. According to the optical module 310 in the present embodiment, it is possible to stably dispose the parallelizing element 162 with respect to the light guide element 142, to prevent a damage due to scratching of the parallelizing element 162 or falling off from the light guide element 142, and to reduce a decrease in the display quality due to color unevenness or the like of the green light LG emitted from the parallelizing element 162.

The projector 350 according to the present embodiment includes the optical module 310 in the present embodiment and the projection optical system 320 that projects the green light (light) LG emitted from the optical module 310.

Since the projector 350 according to the present embodiment includes the optical module 310 as described above, it is possible to ensure the quality of the image light IG generated based on the green light LG and to improve the use efficiency of the image light IG. According to the projector 350 in the present embodiment, it is possible to secure the display quality and further improve the light use efficiency in consideration of the manufacturing error of the components during mass production according to the dimensions, the specifications, and the parameters related to the optical characteristics of the light source 122 constituting the pseudo light source of the green light LG, the shape and the dimension of the light guide element 142, the shape and the dimension of the parallelizing element 162, the refractive index, and the like.

In the optical module 310 and the projector 350 according to the present embodiment, in at least one of color light emitting portions, including the red light emitting portion 101, the green light emitting portion 102, and the blue light emitting portion 103, a configuration, a design guideline, and preferable conditions as described above in detail for the green light emitting portion 102 may be applied. In all of the color light emitting portions, including the red light emitting portion 101, the green light emitting portion 102, and the blue light emitting portion 103, it is more desirable to apply the configuration, the design guideline, and the preferable conditions as described above in detail for the green light emitting portion 102. As a result, in the optical module 310 and the projector 350 according to the present embodiment, it is possible to secure full-color display quality and further improve the light use efficiency.

Some preferable embodiments of the present disclosure have been described hereinabove in detail. However, the present disclosure is not limited to such specific embodiments, and various modifications and changes can be made thereto within the scope of the present disclosure set forth in the appended claims.

For example, similarly to the green light emitting portion 102, in the red light emitting portion 101 and the blue light emitting portion 103, the LED constituting the light sources 121 and 123 may include a phosphor that is excited by the light from the LED main body and emits the red light LR and the blue light LB. Color light other than the color light corresponding to each of the light emitting portions may be emitted from the LED constituting the light sources 121, 122, and 123 or a light source other than the LED, and the color light other than the color light corresponding to each of the light emitting portions may be converted into the color light corresponding to each of the light emitting portions by a color filter. Specifically, in the light source 122, blue light may be emitted from the LED main body as excitation light, yellow light may be emitted from the phosphor, and the yellow light may be converted into the green light LG by a color filter disposed on the incident side or the emission side of the light guide element 142. Similarly, in the light source 121, blue light may be emitted from the LED main body as excitation light, yellow light may be emitted from the phosphor, and the yellow light may be converted into the red light LR by a color filter disposed on the incident side or the emission side of the light guide element 141.

For example, the light guide elements 141, 142, and 143 may each be a reflector made of a transparent material having a refractive index higher than that of air, such as optical glass and quartz, or may be formed as a solid member. When the light guide elements 141, 142, and 143 are each a solid member made of the transparent member described above, the reflection surfaces 141r, 142r, and 143r are implemented with side surfaces of the solid member that face outward. Most of each of the red light LR, the green light LG, and the blue light LB incident on the light guide elements 141, 142, and 143 via the incident ends 141a, 142a, and 143a is totally reflected by the reflection surfaces 141r, 142r, and 143r toward the emission ends 141b, 142b, and 143b.

### Summary of Present Disclosure

The present disclosure will be summarized below as appendices.

(Appendix 1) An optical module includes: a first light source configured to emit first light in a first wavelength band; a first pickup element configured to reduce a spread angle of the first light emitted from the first light source; and a first light modulation element configured to modulate the first light emitted from the first pickup element based on image information. The first light modulation element has a light receiving region that receives light emitted from the first pickup element, the first pickup element has a first light guide element, the first light guide element includes a first incident end on which the first light is incident and a first emission end that emits the first light, and homogenizes in-plane illuminance of the first light, and 1.1×AR1≤AR2≤1.9×AR1, and ET2=π×AR3×sin²θ1≤ET1, where an area of the light receiving region when viewed along an optical axis of the light is AR1, an area of the first emission end of the first light guide element on which the first light is emitted is AR2, an area of the first incident end of the first light guide element on which the first light is incident is AR3, an angle formed by the first light emitted from the first pickup element with respect to the optical axis is θ1, an etendue of the light receiving region in the first light modulation element is ET1, and an etendue in an emission region of the first light incident on the first pickup element is ET2.

$$1.1 \times AR 1 \leq AR 2 \leq 1.9 \times AR 1 \qquad ( 1 )$$

$$ET 2 = π \times AR 3 \times {sin}^{2} θ1 \leq ET 1 \qquad ( 2 )$$

According to the configuration of Appendix 1, it is possible to secure the display quality and further improve light use efficiency in the optical module in consideration of a manufacturing error of components during mass production according to a dimension and a specification of the first light source, parameters related to optical characteristics, a shape and a dimension of the first light guide element, a shape, a dimension, and a refractive index of the first pickup element, and the like.

(Appendix 2) In the optical module according to Appendix 1, the first pickup element includes the first light guide element on which the first light emitted from the first light source is incident and a first parallelizing element that parallelizes the first light emitted from the first light guide element, and the first light emitted from the first parallelizing element is incident on the first light modulation element.

According to the configuration of Appendix 2, the spread angle of the first light emitted from the first light source can be reduced by the first light guide element, and the spread angle of the first light emitted from the first light guide element can be further reduced by the first parallelizing element.

(Appendix 3) In the optical module according to Appendix 1, the first pickup element includes a converging element on which the first light emitted from the first light source is incident and the first light guide element on which the first light emitted from the converging element is incident, and the first light emitted from the first light guide element is incident on the first light modulation element.

According to the configuration of Appendix 3, the spread angle of the first light emitted from the first light source can be reduced by the converging element, and the spread angle of the first light emitted from the converging element can be easily adjusted by the first light guide element.

(Appendix 4) The optical module according to any of Appendices 1 to 3 further includes: a second light source configured to emit second light in a second wavelength band different from the first wavelength band; a third light source configured to emit third light in a third wavelength band different from the first wavelength band and the second wavelength band; a second pickup element configured to reduce a spread angle of the second light emitted from the second light source; a second light modulation element configured to modulate the second light emitted from the second pickup element based on image information; a third light modulation element configured to modulate the third light emitted from the third light source based on image information; a light combining element configured to combine the first light emitted from the first light modulation element, the second light emitted from the second light modulation element, and the third light emitted from the third light modulation element and emit the combined light; and a projection optical system configured to project light emitted from the light combining element.

According to the configuration of Appendix 4, it is possible to appropriately reduce the decrease in the display quality due to the first light in the optical module, improve the use efficiency of the first light, and favorably reduce the loss of the first light in the first light modulation element. By applying the same configuration, it is possible to appropriately reduce of display quality due to the first light, the second light, and the third light in the optical module, and to improve the use efficiency of each type of light.

(Appendix 5) In the optical module according to any one of Appendices 1 to 4, a diagonal size of the light receiving region is 0.5 inches or more and 1.9 inches or less.

According to the configuration of Appendix 5, since a diagonal size of the light receiving region is within an appropriate range, it is possible to improve the light use efficiency in the first light modulation element and prevent an excessive increase in size of the first light modulation element.

(Appendix 6) In the optical module according to Appendix 2, 1.1×g≤f≤2.0×g, where a focal length of the first parallelizing element is f, and a length of the first light guide element in a direction along the optical axis is g.

$$1.1 \times g \leq f \leq 2. \times g \qquad ( 3 )$$

With the configuration of Appendix 6, it is possible to increase the use efficiency of the first light incident on the first light guide element from the first incident end and emitted from the emission surface of the first parallelizing element, and to prevent an excessive increase in size of the first light guide element.

(Appendix 7) In the optical module according to Appendix 6, a refractive index of the first parallelizing element is 1.8 or more.

With the configuration of Appendix 7, it is possible to reduce a thickness of the first parallelizing element can be reduced with respect to a predetermined focal length required for the first parallelizing element, and to reduce a size of the first light source, a pseudo light source including the first light guide element and the first parallelizing element, and the first pickup element in a direction along the optical axis of the green light LG.

(Appendix 8) In the optical module according to any one of Appendices 1 to 7, the first light guide element is a hollow member, and the first light guide element includes a first light guide plate having a first plate surface that reflects the first light, a second light guide plate intersecting the first plate surface and having a second plate surface that reflects the first light, a third light guide plate intersecting the second plate surface and having a third plate surface that reflects the first light, and a fourth light guide plate intersecting the third plate surface and the first plate surface and having a fourth plate surface that reflects the first light.

According to the configuration of Appendix 8, the first light guide element can be formed more easily by assembling the first light guide plate, the second light guide plate, the third light guide plate, and the fourth light guide plate than a hollow member in the related art which is integrally molded or implemented by one member.

(Appendix 9) In the optical module according to Appendix 8, the first light guide plate is a quadrangular plate-shaped member, the second light guide plate is a trapezoidal plate-shaped member, the third light guide plate is a quadrangular plate-shaped member, the fourth light guide plate is a trapezoidal plate-shaped member, and the first emission end is larger than the first incident end.

In the configuration of Appendix 9, it is possible to reduce the number of times of processing for cutting out the first light guide plate and the third light guide plate from the plate-shaped base material and the cost, and to stably hold the first light guide plate, the second light guide plate, the third light guide plate, and the fourth light guide plate during assembly. According to the configuration of Appendix 9, a size of the first incident end and a size of the first emission end can be appropriately set, and the first light incident on the first light guide element from the first incident end can be expanded to a desired size according to the size of the first emission end.

(Appendix 10) In the optical module according to any one of Appendices 1 to 9, 1.0×AR4≤AR3≤4.0×AR4, where an area of a light emitting surface of the first light source is AR4.

1.0×AR4≤AR3≤4.0×AR4 (4)

According to the configuration of Appendix 10, it is possible to appropriately reduce the illuminance unevenness of the first light emitted from the light receiving region of the first light modulation element and the decrease in the display quality, improve the use efficiency of the first light received in the light receiving region, and favorably reduce the loss of the first light incident on the first light modulation element. With the configuration of Appendix 8, it is possible to prevent an increase in size of the pseudo light source including the first light source and the first light guide element.

(Appendix 11) In the optical module according to Appendix 2, the first light guide element includes a light guide portion configured to guide the first light from the first incident end toward a first emission end side, and an extending portion extending from a peripheral edge of the light guide portion on the first emission end in a direction along the optical axis along a plane intersecting the optical axis, and the extending portion is in contact with the first parallelizing element.

According to the configuration of Appendix 11, it is possible to stably dispose the first parallelizing element with respect to the first light guide element, to prevent damage due to scratching of the first parallelizing element or falling off from the first light guide element, and to reduce the decrease in the display quality due to color unevenness or the like of the first light emitted from the first parallelizing element.

(Appendix 12) A projector includes: the optical module according to any one of Appendices 1 to 11; and a projection optical system configured to project light emitted from the optical module.

According to the configuration of Appendix 12, it is possible to secure the display quality and further improve the light use efficiency in consideration of the manufacturing error of the components during mass production according to the dimension and the specification of the first light source constituting the pseudo light source of the first light, the parameters related to the optical characteristics, the shape and the dimension of the first light guide element, the shape and the dimension of the first pickup element, the refractive index, and the like.

What is claimed is:

1. An optical module comprising:
a first light source configured to emit first light in a first wavelength band;
a first pickup element configured to reduce a spread angle of the first light emitted from the first light source; and
a first light modulation element configured to modulate the first light emitted from the first pickup element based on image information, wherein
the first light modulation element has a light receiving region that receives light emitted from the first pickup element,
the first pickup element includes a first light guide element,
the first light guide element includes a first incident end on which the first light is incident and a first emission end that emits the first light, and homogenizes in-plane illuminance of the first light, and
$$1.1 \times AR 1 \leq AR 2 \leq 1.9 \times AR 1 , and \\ ET 2 = \prod \times AR 3 \times {sin}^{2} θ1 \leq ET 1 ,$$
wherein an area of the light receiving region when viewed along an optical axis of the light is AR1,
an area of the first emission end of the first light guide element on which the first light is emitted is AR2,
an area of the first incident end of the first light guide element on which the first light is incident is AR3,
an angle formed by the first light emitted from the first pickup element with respect to the optical axis is θ1,
an etendue of the light receiving region in the first light modulation element is ET1, and
an etendue in an emission region of the first light incident on the first pickup element is ET2.

2. The optical module according to claim 1, wherein
the first pickup element includes
the first light guide element on which the first light emitted from the first light source is incident, and
a first parallelizing element that parallelizes the first light emitted from the first light guide element, and
the first light emitted from the first parallelizing element is incident on the first light modulation element.

3. The optical module according to claim 1, wherein
the first pickup element includes
a converging element on which the first light emitted from the first light source is incident, and
the first light guide element on which the first light emitted from the converging element is incident, and
the first light emitted from the first light guide element is incident on the first light modulation element.

4. The optical module according to claim 1, further comprising:
a second light source configured to emit second light in a second wavelength band different from the first wavelength band;
a third light source configured to emit third light in a third wavelength band different from the first wavelength band and the second wavelength band;
a second pickup element configured to reduce a spread angle of the second light emitted from the second light source;
a second light modulation element configured to modulate the second light emitted from the second pickup element based on image information;
a third light modulation element configured to modulate the third light emitted from the third light source based on image information;
a light combining element configured to combine the first light emitted from the first light modulation element, the second light emitted from the second light modulation element, and the third light emitted from the third light modulation element and emit the combined light; and
a projection optical system configured to project light emitted from the light combining element.

5. The optical module according to claim 1, wherein
a diagonal size of the light receiving region is 0.5 inches or more and 1.9 inches or less.

6. The optical module according to claim 2, wherein
$$1.1 \times g \leq f \leq 2. \times g ,$$
wherein a focal length of the first parallelizing element is f, and a length of the first light guide element in a direction along the optical axis is g.

7. The optical module according to claim 6, wherein
a refractive index of the first parallelizing element is 1.8 or more.

8. The optical module according to claim 1, wherein
the first light guide element is a hollow member, and
the first light guide element includes
a first light guide plate having a first plate surface that reflects the first light,
a second light guide plate intersecting the first plate surface and having a second plate surface that reflects the first light,
a third light guide plate intersecting the second plate surface and having a third plate surface that reflects the first light, and
a fourth light guide plate intersecting the third plate surface and the first plate surface and having a fourth plate surface that reflects the first light.

9. The optical module according to claim 8, wherein
the first light guide plate is a quadrangular plate-shaped member,
the second light guide plate is a trapezoidal plate-shaped member,
the third light guide plate is a quadrangular plate-shaped member,
the fourth light guide plate is a trapezoidal plate-shaped member, and
the first emission end is larger than the first incident end.

10. The optical module according to claim 1, wherein
$$1. \times AR 4 \leq AR 3 \leq 4. \times AR 4 ,$$
wherein an area of a light emitting surface of the first light source is AR4.

11. The optical module according to claim 2, wherein
the first light guide element includes
a light guide portion configured to guide the first light from the first incident end toward the first emission end, and
an extending portion extending from a peripheral edge of the light guide portion on the first emission end in a direction along the optical axis along a plane intersecting the optical axis, and
the extending portion is in contact with the first parallelizing element.

12. A projector comprising:
the optical module according to claim 1; and
a projection optical system configured to project light emitted from the optical module.
